(19) United States
(12) Patent Application Publication
(10) Pub. No.: US 2026/0116679 A1
(43) Pub. Date: Apr. 30, 2026

(54) SYSTEM AND METHOD FOR UNLOADING PALLETIZED CARGO FROM A TRANSPORT CONTAINER, AND ASSOCIATED CONFIGURATIONS OF PALLETIZED GAS CYLINDER CARGO

(71) Applicant: YSN Imports, LLC, Commerce, CA (US)

(72) Inventor: Shmuel Dovid Newman, Los Angeles, CA (US)

(21) Appl. No.: 19/488,840

(22) PCT Filed: May 30, 2024
(86) PCT No.: PCT/US2024/031798

§ 371 Date: Nov. 30, 2025

Related U.S. Application Data
(60) Provisional application No. 63/469,818, filed on May 30, 2023.
(60) Provisional application No. 63/646,963, filed on May 13, 2024.

(51) Int. Cl. B65G 67/24

(52) U.S. Cl. CPC B65G 67/24

(57) ABSTRACT

An exemplary palletized cargo unit includes a lower cargo grouping and an upper cargo grouping. The lower cargo grouping may include a base pallet and three layers of gas cylinders disposed thereon. The upper cargo unit may include an intermediate pallet and at least two layers of gas cylinder thereon. The upper and lower groupings are configured to interposingly engage one another in a space-efficient manner, and are separable from one another without disrupting their individual structural integrity. Methods are also provided for efficiently packing a transport container with the maximum number of gas cylinders by way of the palletized cargo units, and safely and efficiently removing the palletized cargo units from the transport container.

### RELATED APPLICATIONS

This application claims the benefit of U.S. Provisional Application No. 63/469,818 filed May 30, 2023 and U.S. Provisional Patent Application No. 63/646,963 filed May 13, 2024. The contents of each of the above-identified applications are hereby incorporated by reference in the entireties as though fully and completely set forth herein.

### TECHNICAL FIELD

The present disclosure relates generally to systems and methods for packing, transporting, and removing palletized cargo from transport containers, such as semi-truck trailers. This disclosure also relates to methods for palletizing gas cylinders, such as those used for storage and delivery of propane.

### SUMMARY

Certain deficiencies of the prior art are overcome by the provision of a system and method for unloading palletized cargo from a transport container, and associated configuration of palletized gas cylinder cargo, as disclosed herein.

### BRIEF DESCRIPTION OF THE DRAWINGS

Further advantages of the present invention may become apparent to those skilled in the art with the benefit of the following detailed description of the preferred embodiments and upon reference to the accompanying drawings in which:

FIG. 1 is a diagrammatic side view of one example of a system for unloading palletized cargo units from a transport container, wherein a set of palletized cargo units is shown within the transport container prior to the forklift removing the palletized cargo units, and a door threshold sensor is affixed at the door threshold of the transport container;

FIG. 2 is a diagrammatic top view of an example transport container, showing a preceding palletized cargo unit and a subsequent palletize cargo unit therein;

FIG. 3 is a diagrammatic rear view of the example transport container in FIG. 2;

FIG. 4 is a diagrammatic side view illustrating a step following what is shown in FIG. 1, wherein the forklift is now shown having removed a palletized cargo unit closest to the door threshold of the transport container, thereby causing the base pallet of that removed unit to drag the extraction line terminal end of the next sequential palletized cargo unit through the door threshold;

FIG. 5 is a diagrammatic side view illustrating a step following that of FIG. 4, wherein the forklift has now moved the first palletized cargo unit aside, and has returned to the door threshold to retrieve the next palletized cargo unit in sequence;

FIG. 6 is a diagrammatic side view illustrating a step following that of FIG. 5, wherein the forklift driver has now extended an extraction line retrieval staff to retrieve the extraction line of the next sequential palletized cargo unit;

FIG. 7 is a diagrammatic side view illustrating a step following that of FIG. 6, wherein the forklift driver has now used the extraction line retrieval staff to pull the terminal end of the extraction line toward a line securement element attached to the forklift;

FIG. 8 is a diagrammatic side view illustrating a step following that of FIG. 7, wherein the forklift driver has now attached the terminal end to the line securement element;

FIG. 9 is a diagrammatic side view illustrating a step following that of FIG. 8, wherein the forklift has now backed away from the door threshold to slidably pull the base pallet of the respective palletized cargo unit toward the door threshold where it triggers the door threshold sensor to inform the forklift driver to stop backing up;

FIG. 10 is a diagrammatic side view illustrating a step following that of FIG. 9, wherein base pallet of the respective palletized cargo unit has now been pulled to the door threshold, the forks of the forklift are fully inserted through that base pallet, and the terminal end of the extraction line of the subsequent palletized cargo unit has been dragged toward the door threshold by the preceding palletized cargo unit about to be removed;

FIG. 11 is a diagrammatic side view illustrating a step following that of FIG. 10, wherein the preceding palletized cargo unit has been removed from the transport container by the forklift, the terminal end of the extraction line of the subsequent palletized cargo unit has been dragged through the door threshold by the preceding palletized cargo unit, and the forklift driver is preparing to use a cutting tool to cut the extraction line so it can be removed from the base pallet of the preceding palletized cargo unit;

FIG. 12 is a diagrammatic side view illustrating a step following that of FIG. 12, wherein the forklift has now moved the preceding palletized cargo unit aside, and has returned to the door threshold to remove the subsequent palletized cargo unit in the same fashion as the preceding palletized cargo unit;

FIG. 13 is a diagrammatic side view similar to that of FIG. 4, but illustrates the start of an alternate embodiment of a system and method modified to that shown in FIGS. 4-12, wherein in this embodiment the line securement element is a pallet winch assembly affixed to the forklift, and the system and method do not employ a door threshold sensor;

FIG. 14 is a diagrammatic side view illustrating a step following that of FIG. 13, wherein the forklift has now moved the first palletized cargo unit aside, and has returned to the door threshold to retrieve the next palletized cargo unit in sequence;

FIG. 15 is a diagrammatic side view illustrating a step following that of FIG. 14, wherein the forklift driver has now extended an extraction line retrieval staff through the winch line guide assembly to retrieve the extraction line of the next sequential palletized cargo unit;

FIG. 16 is a diagrammatic side view illustrating a step following that of FIG. 15, wherein the forklift driver has now used the extraction line retrieval staff to pull the terminal end of the extraction line through the winch line guide assembly and to the pallet winch assembly;

FIG. 17 is a diagrammatic side view illustrating a step following that of FIG. 16, wherein the forklift driver has now attached the terminal end to the line securement flange of the pallet winch assembly;

FIG. 18 is a diagrammatic side view illustrating a step following that of FIG. 17, wherein the forklift has now begun to insert the forks into the cargo compartment while the winch assembly is activated to reel in the extraction line, thereby slidably pulling the base pallet of the respective palletized cargo unit toward the door threshold;

FIG. 19 is a diagrammatic side view illustrating a step following that of FIG. 18, wherein base pallet of the respective palletized cargo unit has now been pulled to the door threshold, the forks of the forklift are now fully inserted under that base pallet, and the terminal end of the extraction line of the subsequent palletized cargo unit has been dragged partially toward the door threshold by the preceding palletized cargo unit;

FIG. 20 is a diagrammatic side view illustrating a step following that of FIG. 19, wherein the preceding palletized cargo unit has been removed from the transport container, the terminal end of the extraction line of the subsequent palletized cargo unit has been dragged through the door threshold by the preceding palletized cargo unit, and the forklift driver is preparing to use a cutting tool to cut the extraction line so it can be removed from the base pallet of the preceding (removed) palletized cargo unit;

FIG. 21 is a diagrammatic side view illustrating a step following that of FIG. 20, wherein the forklift has now moved the preceding palletized cargo unit aside, and has returned to the door threshold to remove the subsequent palletized cargo unit in the same fashion as the preceding palletized cargo unit;

FIG. 22 is a diagrammatic top view illustrating example positions of a set of 20 palletized cargo units within an example transport container, and the comparative extended lengths of the respective extraction lines;

FIG. 23 is a diagrammatic illustration of one example of a line securement element in the form of a line catch affixed to the forklift;

FIG. 24 is a diagrammatic top view illustrating an example extraction line comprised of a single segment of rope with opposing rope ends, the terminal end of the winch line being defined by a joining of the rope ends, the securement end of the extraction line being defined by a loop portion of the rope between the rope ends;

FIG. 25 is a diagrammatic perspective view of one example of a line securement element in the form of a pallet winch assembly with corresponding winch line guide assembly, both of which may be mountable to a forklift;

FIG. 26 is a further diagrammatic perspective view of the example pallet winch assembly and corresponding winch line guide assembly of FIG. 25;

FIG. 27 is another diagrammatic perspective view of the example pallet winch assembly and corresponsive winch line guide assembly of FIG. 25;

FIG. 28 is another diagrammatic perspective view of the example pallet winch assembly and corresponding winch line guide assembly of FIG. 25;

FIG. 29 is a diagrammatic front view of the example pallet winch assembly and corresponding winch line guide assembly of FIG. 25;

FIG. 30 is a diagrammatic partially exploded view of the example pallet winch assembly in FIG. 25, illustrating how winch assembly mounting brackets and corresponding fasteners may be provided to mount the pallet winch assembly to existing frame uprights of a conventional forklift;

FIG. 31 is a diagrammatic perspective view of the example pallet winch assembly in FIG. 25, but wherein the spool retention flange is shown having been threadedly removed from the winch axle by way of manual rotation of the flange torsion handle;

FIG. 32 is a diagrammatic perspective view similar to that of FIG. 31, but now showing the line sleeve having been slidably removed from the winch axle to facilitate removal of a severed spool of winch line (not shown) from the line sleeve;

FIG. 33 is a diagrammatic perspective view of one example extraction line retrieval staff with hook;

FIG. 34 is a diagrammatic top view of the example extraction line retrieval staff of FIG. 32;

FIG. 35 is a diagrammatic front view of one example of a palletized cargo unit;

FIG. 36 is a diagrammatic side view of the example palletized cargo unit shown in FIG. 35;

FIG. 37 is a diagrammatic top view of the example palletized cargo unit shown in FIG. 35, with the supplemental container not shown;

FIG. 38 is a diagrammatic cross-sectional view taken across lines 38-38 in FIG. 35;

FIG. 39 is a diagrammatic cross-sectional view similar to that of FIG. 38, but wherein the palletized cargo unit is rotated 180 degrees so that order of the stack channels and the stack protrusions from left to right is reversed, thus enabling respective stack channels and stack protrusions of sequentially adjacent palletized cargo units to engage with one another to maximize the use of space within the transport container;

FIG. 40 is a diagrammatic side view of an example conventional gas cylinder;

FIG. 41 is a diagrammatic rear view of the conventional gas cylinder in FIG. 40;

FIG. 42 is a diagrammatic top view of the conventional gas cylinder in FIG. 40;

FIG. 43 is a diagrammatic bottom view of the conventional gas cylinder in FIG. 40;

FIG. 44 is a diagrammatic bottom perspective view of an example base pallet with sled rails on the bottom and lateral guides on top, the ends of the sled rails being upwardly chamfered and the lateral peripheries of the base pallet being longitudinally chamfered;

FIG. 45 is a diagrammatic top perspective view of the example base pallet of FIG. 44;

FIG. 46 is a diagrammatic top wireframe view of the example base pallet of FIG. 44;

FIG. 47 is a diagrammatic top perspective view of an example intermediate pallet with handle pass-through apertures to receive corresponding tank handle portions;

FIG. 48 is a diagrammatic bottom perspective view of the example intermediate pallet of FIG. 47;

FIG. 49 is a diagrammatic perspective view illustrating rubber banding of four adjacent gas cylinders to one another to improve overall stability of the palletized load;

FIG. 50 is a diagrammatic perspective view illustrating one example sixth array configuration;

FIG. 51 is a diagrammatic top view of the example sixth array configuration shown in FIG. 50;

FIG. 52 is a diagrammatic front view of another example of a palletized cargo unit;

FIG. 53 is a diagrammatic left side view of the palletized cargo unit of FIG. 52;

FIG. 54 is a diagrammatic right side view of the palletized cargo unit of FIG. 52;

FIG. 55 is a diagrammatic top perspective view of the palletized cargo unit of FIG. 52;

FIG. 56 is a diagrammatic bottom perspective view of the palletized cargo unit of FIG. 52;

FIG. 57 is a diagrammatic cross-sectional view taken along lines 57-57 in FIG. 52;

FIG. 58 is a diagrammatic magnified view of detail 58 in FIG. 57;

FIG. 59 is a diagrammatic magnified view of detail 59 in FIG. 57;

FIG. 60 is a diagrammatic front view of the palletized cargo unit similar to that of FIG. 52, but wherein the palletized cargo unit includes a plastic wrapping enveloping and collectively securing all of the arrays and the intermediate pallet;

FIG. 61 is a diagrammatic front view of a further example of a palletized cargo unit similar to that of FIG. 52, but wherein the first and second horizonal straps are each positioned at the handle portions of the respective array of gas cylinders, and additional vertical securement straps are provided to facilitate the securement of the gas cylinders of the sixth array to the remainder of the upper cargo grouping;

FIG. 62 is a diagrammatic left side view of the example palletized cargo unit of FIG. 62;

FIG. 63 illustrates an extraction line being passed through a coupling aperture in sled rails of a base pallet to establish a looped coupling of the extraction line to the base pallet;

FIG. 64 illustrates a securement end of the extraction line having been formed as a loop in a single segment of rope passed through the coupling apertures, thus the extraction line is now coupled to the base pallet;

FIG. 65 illustrates an extraction line coupled to a base pallet with the terminal end formed in a knot, wherein the extraction line is in a bundled configuration and is releasably attached to the corresponding palletized cargo unit;

FIG. 66 is a front perspective view of an example palletized cargo unit with the extraction line in an extended configuration;

FIG. 67 illustrates one means by which terminal end of the extraction line of the subsequent palletized cargo unit may be draggably attached to the preceding palletized cargo unit;

FIG. 68 illustrates the extraction line passing through the winch line guide assembly and toward the pallet winch assembly;

FIG. 69 illustrates the extraction line starting to be reeled by activation of the pallet winch assembly;

FIG. 70 illustrates the extraction line of the subsequent palletized cargo unit being dragged through the door threshold by removal of the preceding palletized cargo unit by the forklift;

FIG. 71 illustrates the forklift driver threadedly removing the spool retention flange so that they can then remove the line sleeve with the spooled portion of the used extraction line;

FIG. 72 illustrates the forklift driver removing the line sleeve with the spooled portion of the used extraction line from the winch axle;

FIG. 73 illustrates the line sleeve having been reinstalled on the winch axle with the previously-used extraction line having been removed;

FIG. 74 is an example of loading details for palletized cargo units, wherein the stack channels and stack protrusions of sequential palletized cargo units engage with one another to maximize the use of space within the transport container;

FIG. 75 is an example of pallet details for one example of a base pallet;

FIG. 76 is an example of pallet details for one example of an intermediate pallet;

FIG. 77 is a diagrammatic illustration of an example door view from outside the door threshold of an example transport container, showing a pair of initial palletized cargo units positioned proximate the door threshold, along with associated dimensions of the interior of the example transport container;

FIG. 78 is a diagrammatic top view of one example system for unloading palletized cargo units from a transport container by way of a forklift, showing respective palletized cargo units within the example transport container along with associated dimensions of the interior of a transport container which is a conventional 40-foot high-cube shipping container;

FIG. 79 is a diagrammatic top view similar to that of FIG. 78, but wherein the illustration shows the cylinder count of each palletized cargo unit, along with the resulting total cylinder count within the transport container which is a conventional 40-foot high-cube shipping container;

FIG. 80 is a diagrammatic illustration of one example palletized cargo unit, showing the height of the unit and the number of gas cylinders contained therein;

FIG. 81 is a diagrammatic illustration of the example palletized cargo unit of FIG. 80, but wherein the palletized cargo unit is shown having been separated into an upper cargo grouping and a lower cargo grouping, including an indication of the respective heights of those groupings (in millimeters) and the number of gas cylinders contained therein;

FIGS. 82-88 are diagrammatic illustrations of an example sequence of steps in an example method for unloading palletized cargo from a transport container in accordance with the present disclosure;

FIG. 89 is a diagrammatic illustration of one example first step in the breakdown of a palletized cargo palletized cargo unit, wherein the plastic wrapping enveloping and collectively securing all of the arrays and the intermediate pallet is cut along a cut line at the intermediate pallet, thereby allowing the upper cargo grouping to be separated from the lower cargo grouping without requiring the securement straps to be removed from the upper or lower cargo grouping;

FIG. 90 is a diagrammatic view of the palletized cargo unit of FIG. 89 after the upper cargo grouping is separated from the lower cargo grouping by way of a forklift raising the upper cargo grouping off of the lower cargo grouping without requiring the securement straps to be removed from the upper or lower cargo grouping;

### DETAILED DESCRIPTION OF THE PREFERRED EMBODIMENTS

Referring now to the drawings, like reference numerals designate identical or corresponding features throughout the several views.

With reference to the several drawings, certain example implementations of a system for unloading palletized cargo from a transport container are shown generally at 100. Furthermore, certain example implementations of a palletized cargo unit are shown generally a 102. Wherever a prime symbol is used in this disclosure immediately following a reference numeral, that is intended to indicate a specific instance of the feature associated with that reference number. For instance, while reference numeral 102 refers generally to a palletized cargo unit, 102′ and 102″ each refer to specific instance of a palletized cargo unit 102.

Referring to FIGS. 1, 2 and 4, a system 100 for unloading palletized cargo units 102 from a transport container 166 by way of a forklift 246 may comprise a set 103 of palletized cargo units 102. The set of palletized cargo units 102 may be placed a sequential arrangement along a transfer axis (188, 190) within the transport container 166. The transfer axis (188, 190) may extend from a closed end 170 of the transport container 166 to a door threshold 172 of the transport container 166.

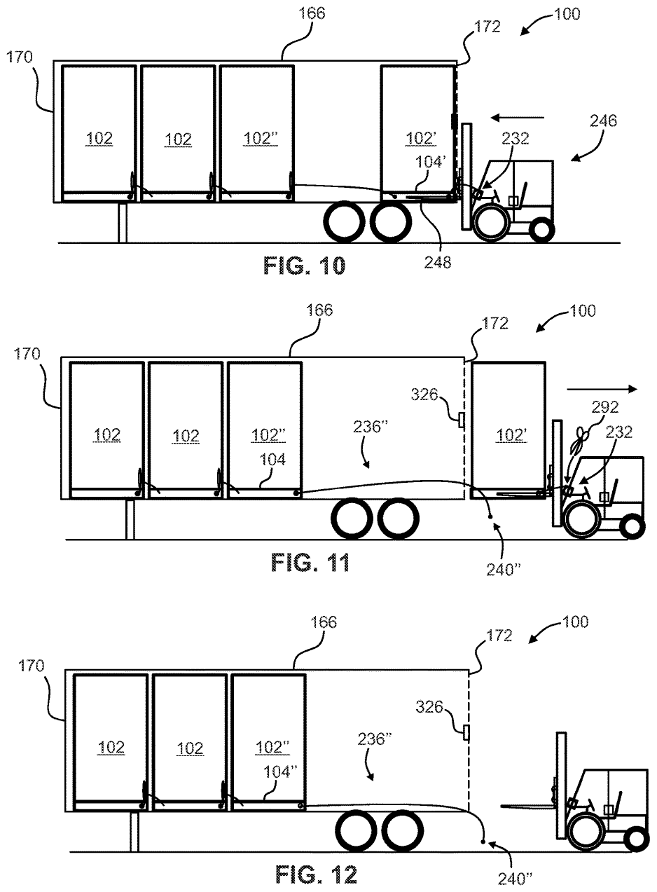

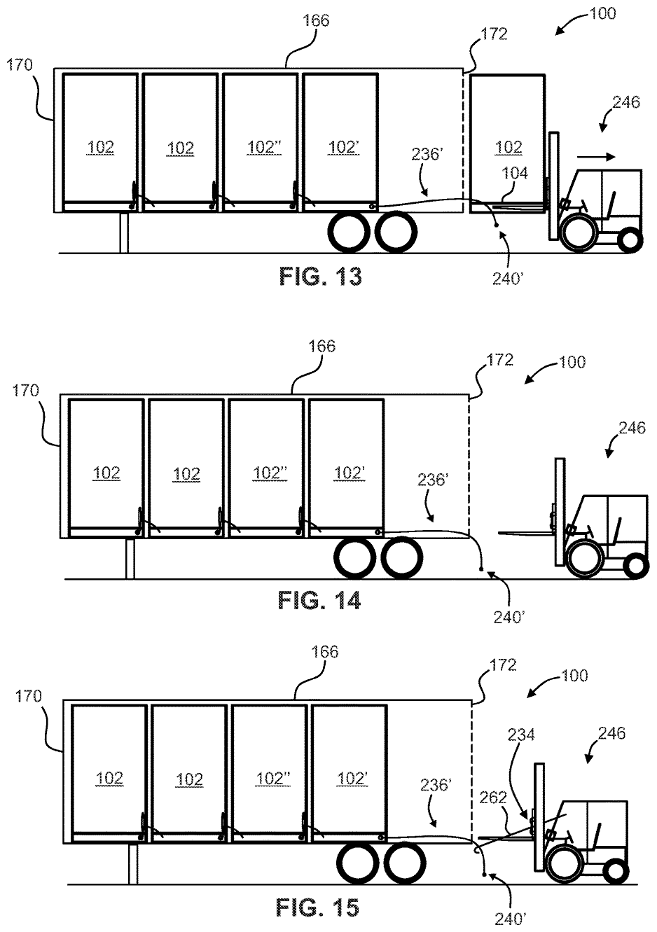

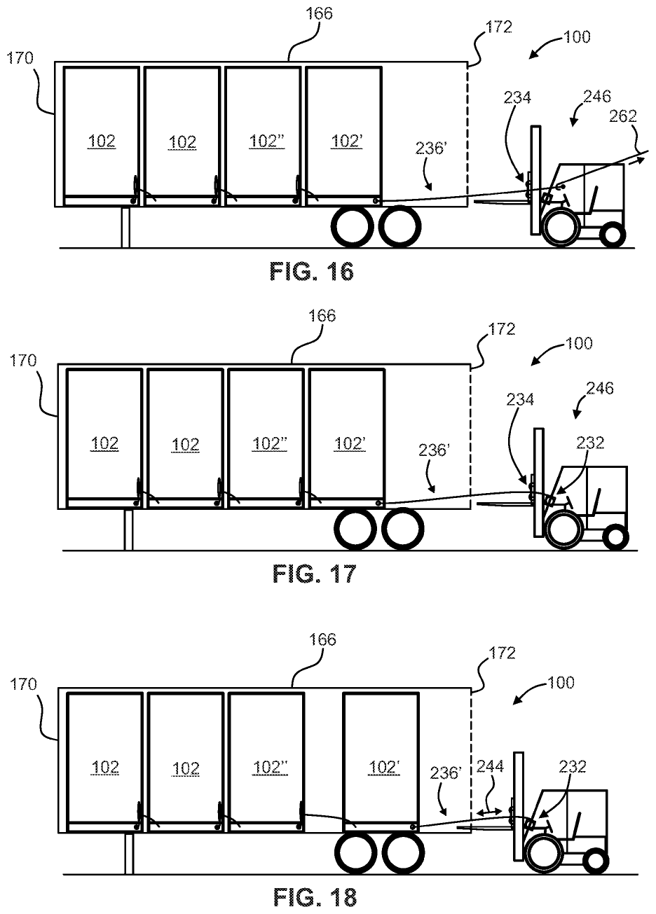

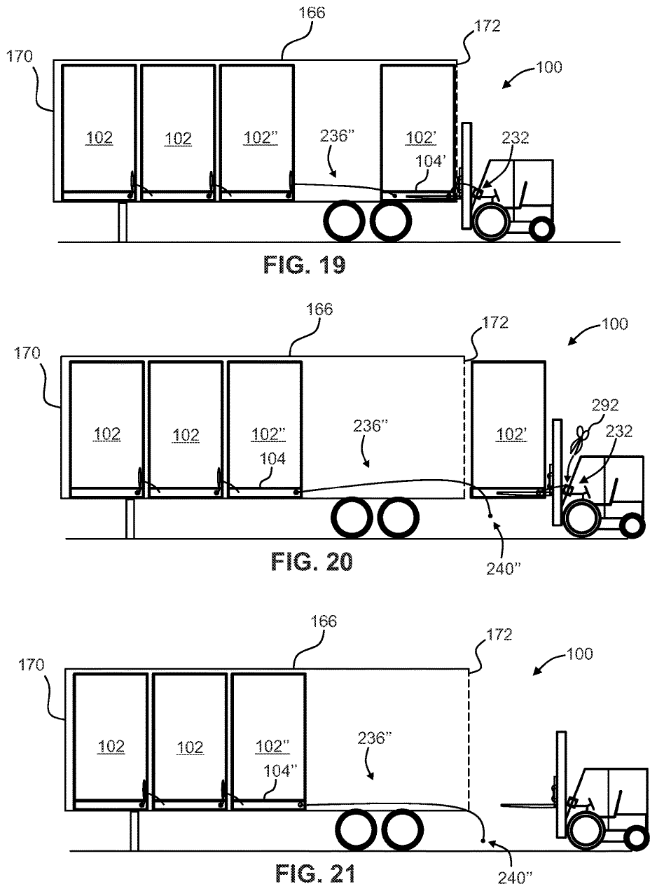

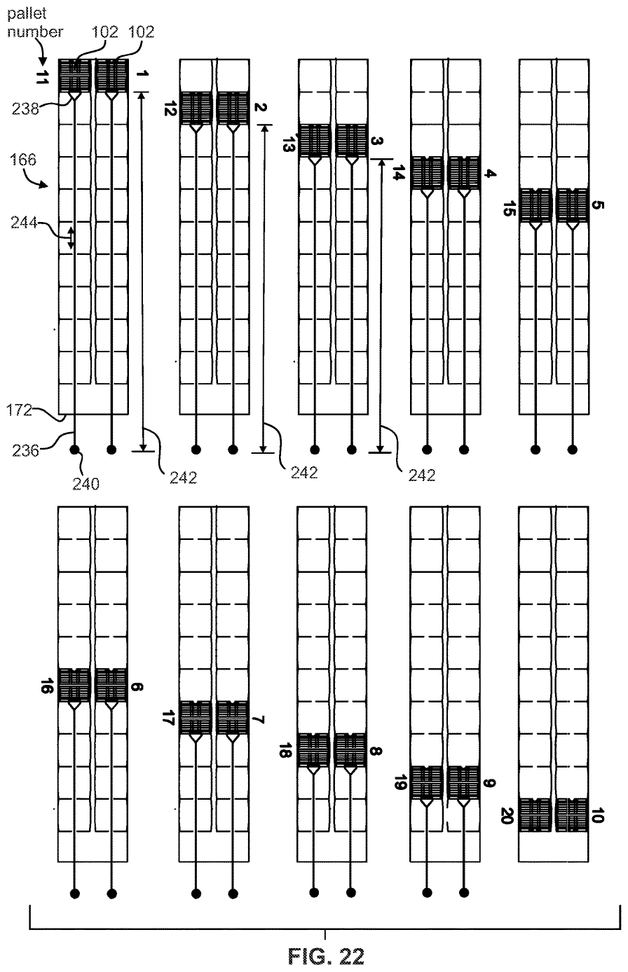

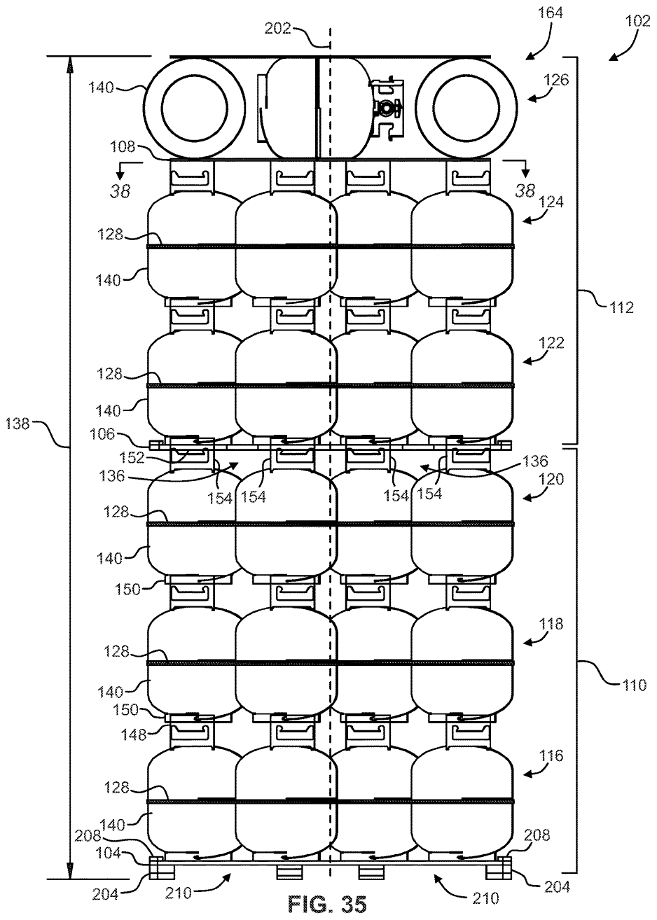

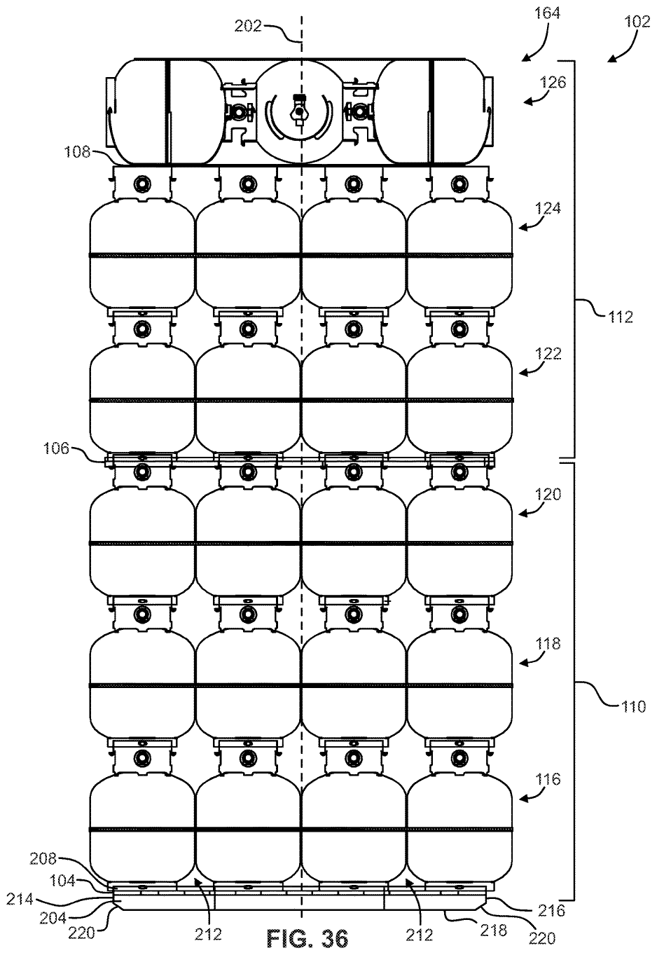

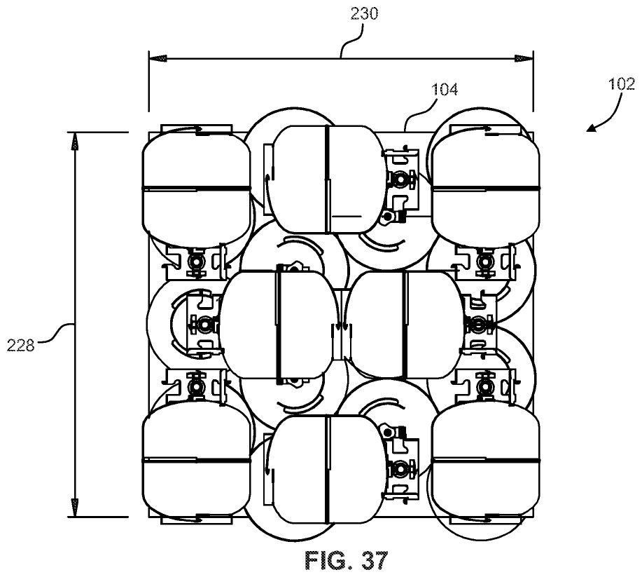

Referring to FIGS. 1 and 22, each palletized cargo unit 102 in the set may have a respective transport position 108 within the sequential arrangement. Referring to FIG. 35, each palletized cargo unit 102 may also have a base pallet 104 on which a cargo load 164 is supported. Referring to FIG. 10, the base pallet 104 may be configured to receive forks 248 of the forklift 246 when the base pallet 104 is at the door threshold 172.

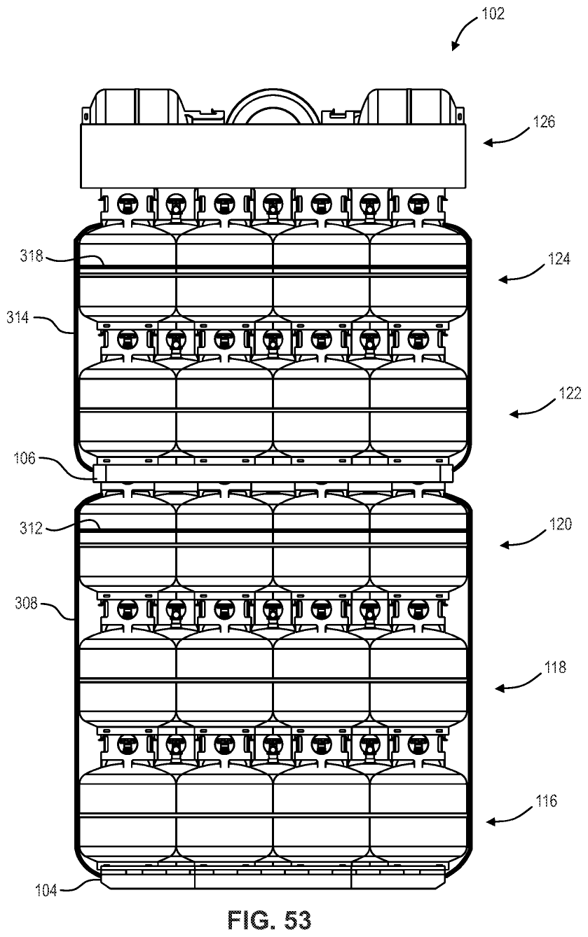

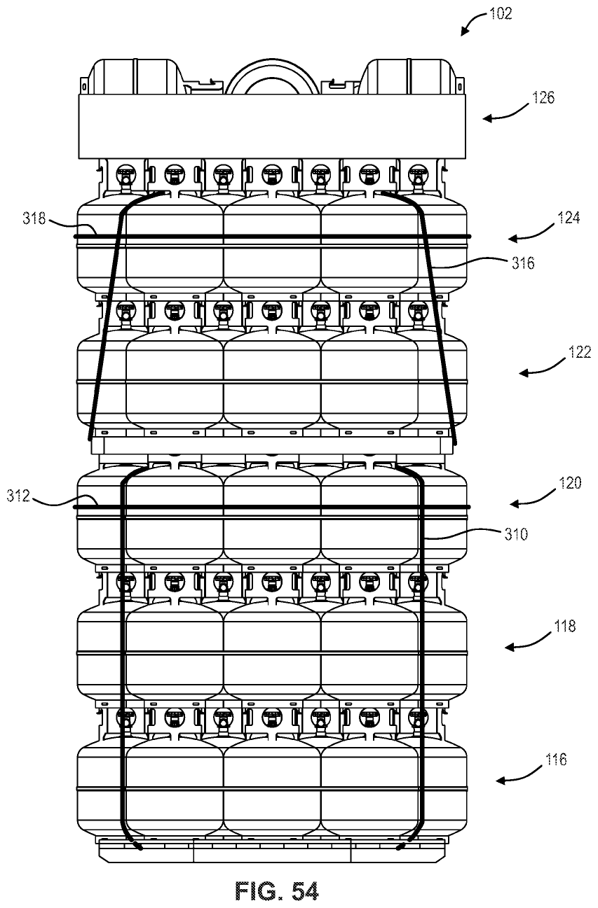

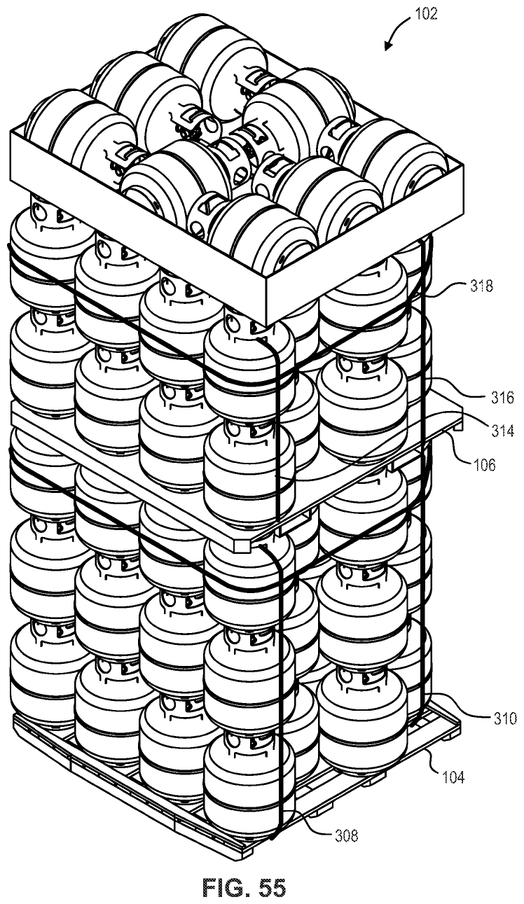

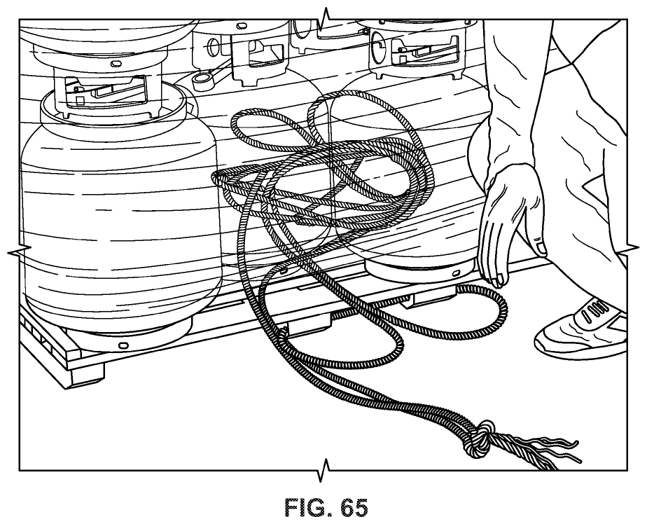

Referring to FIGS. 10 and 22, each palletized cargo unit 102 may have an extraction line 236. The extraction line 236 may have a securement end 238 and a terminal end 240. Referring to FIG. 53, the securement end 238 may be coupled to the base pallet 104. Moreover, the extraction line 236 may be reconfigurable between a bundled configuration (see, e.g., FIG. 65) and an extended configuration (see, e.g., FIG. 53). Referring to FIG. 22, the extraction line may have an extended length 242 when in the extended configuration. The extended length 242 may be sufficient to enable the terminal end 240 of each respective palletized cargo unit 102 to extend outward of the door threshold 172 when the palletized cargo unit 102 is in its respective transport position 108.

Referring to FIGS. 1, 2 and 9, for each of the palletized cargo units 102 in the set 103, the base pallet 104 may be slidably pullable toward the door threshold 172 away from the closed end 170 by way of line tension 244 applied to the extraction line 236. The line tension 244 may be configured to be applied by way of a line securement element 232 of a forklift 246.

Referring to FIGS. 10-12, regarding the set 103 of palletized cargo units 102, for each subsequent palletized cargo unit (e.g., 102″) having a preceding palletized cargo unit (e.g., 102′) sequentially disposed closer to the door threshold 172, the terminal end 240 of the extraction line 236 of the subsequent palletized cargo unit (e.g., 102″) may be draggably attached to the preceding palletized cargo unit (e.g., 102′). In particular preferred implementations of the system 100, the draggable attachment may be configured to cause the terminal end (e.g. 240″) of the extraction line (e.g., 236″) of the subsequent palletized cargo unit (e.g., 102″) to be dragged through the door threshold 172 by way of (a) the slidable pulling of the base pallet (e.g., 104′) of the preceding palletized cargo unit (e.g., 102′) and (b) removal of the preceding palletized cargo unit (e.g., 102′) from the transport container 166 by the forklift 246.

Referring to FIGS. 10-12, in certain preferred implementations of the system 100, for each subsequent palletized cargo unit (e.g., 102″) having a preceding palletized cargo unit (e.g., 102′) sequentially disposed closer to the door threshold 172, (a) the extraction line 236 of the subsequent palletized cargo unit (e.g., 102″) may be in the bundled configuration, and (b) the draggable attachment may be configured to allow the extraction line 236 of the subsequent palletized cargo unit (e.g., 102″) to gradually convert from the bundled configuration to the extended configuration during the slidable pulling of the base pallet (e.g., 104′) of the preceding palletized cargo unit (e.g., 102′), and removal of the preceding palletized cargo unit (e.g., 102′) from the transport container 166 by the forklift 246.

Referring to FIGS. 10-12, in certain preferred implementations of the system 100, for each of the subsequent palletized cargo units (e.g., 102″), the draggable attachment of the extraction line 236 to the preceding palletized cargo unit (e.g., 102′) may be configured to fully release upon the preceding palletized cargo unit (e.g., 102′) being moved away from the transport container 166 by the forklift 246.

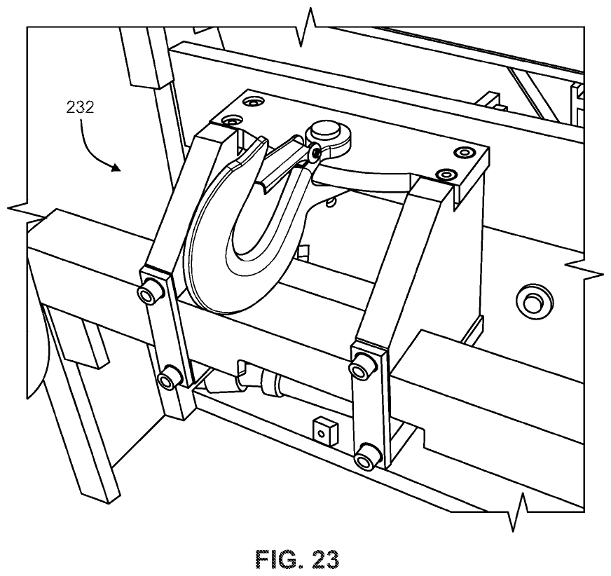

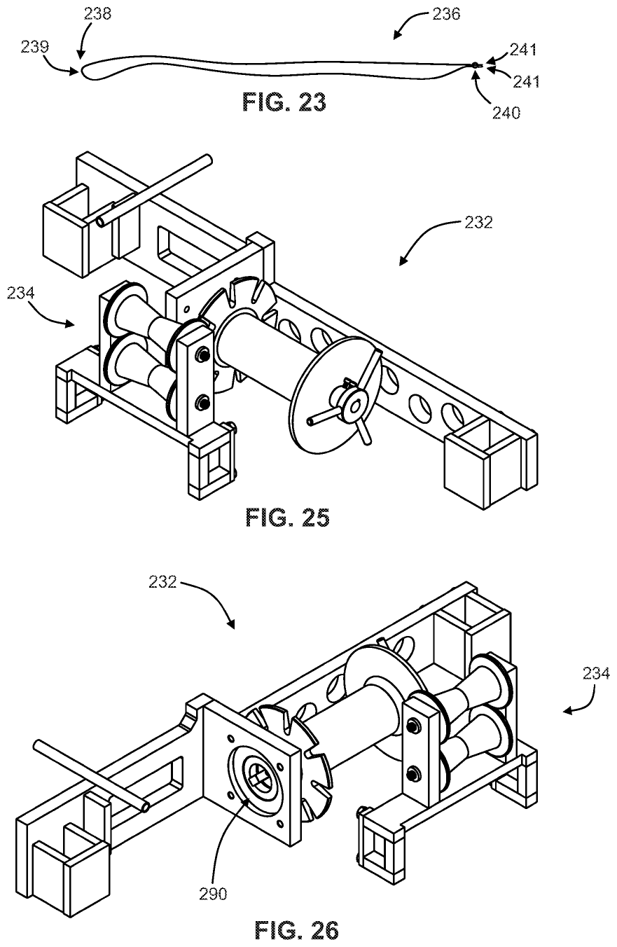

Referring to FIGS. 23 and 53, in particular implementations of the system 100, the extraction lines 236 may preferably be comprised of a single segment of rope with opposing rope ends 241. In such implementations, the terminal end 240 of the extraction line 236 may be defined by a joining of the rope ends. The joining of the rope ends 241 may be by way of a knot or the like. Moreover, the securement end 238 of the extraction line 236 may be defined by a loop portion of the rope disposed between the rope ends.

Referring to FIG. 65, for each subsequent palletized cargo unit (e.g., 102″) having a preceding palletized cargo unit (e.g., 102′) sequentially disposed closer to the door threshold 172, most of the extraction line 236 of the subsequent palletized cargo (e.g., 102″) unit may be releasably attached to the subsequent palletized cargo unit (e.g., 102″) when the extraction line 236 is in the bundled configuration.

For each palletized cargo unit 102 in the set 103, the coupling of the securement end 238 to the base pallet 104 may be configured to be released by cutting the rope and pulling the extraction line 236 away from the base pallet 104.

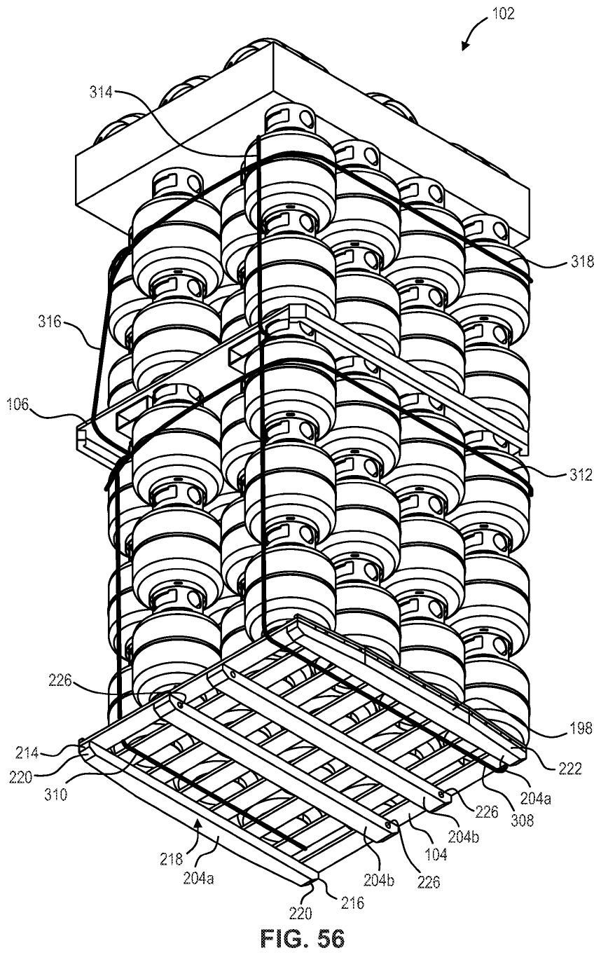

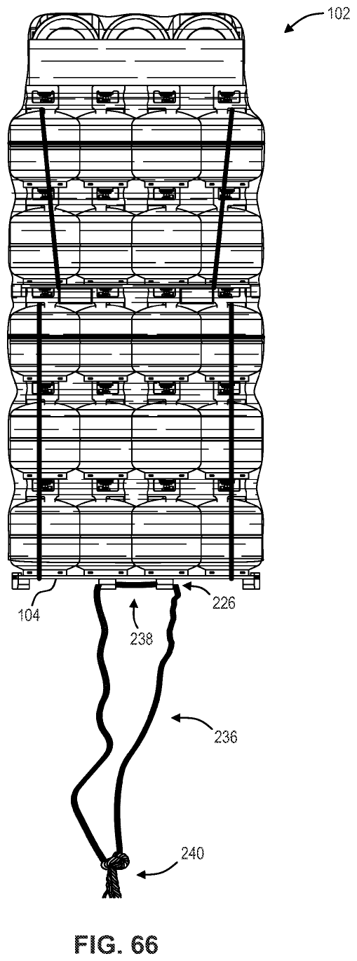

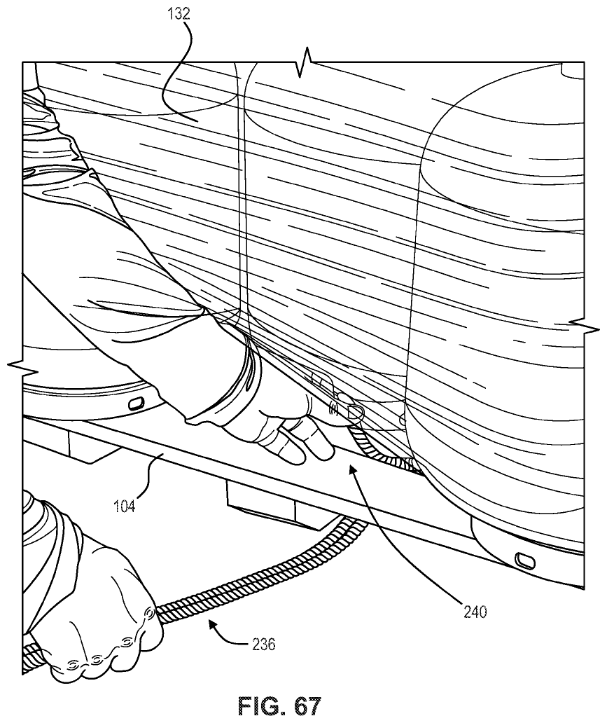

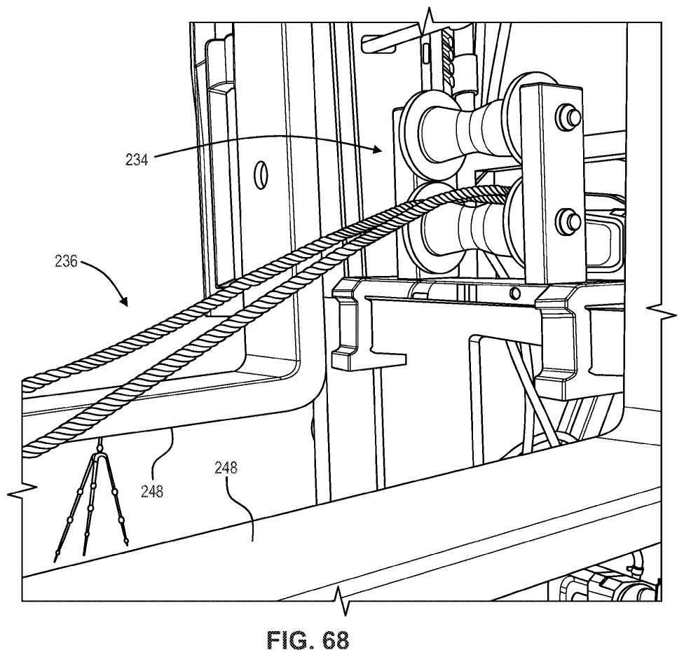

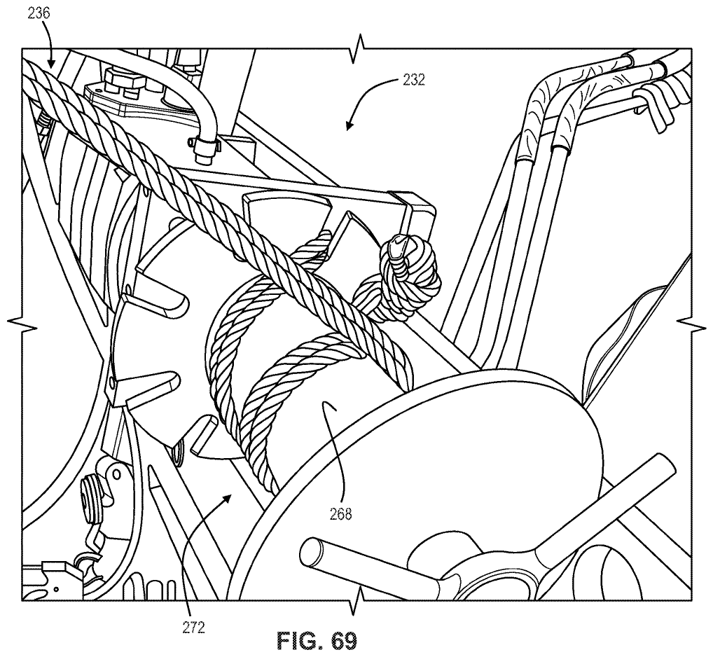

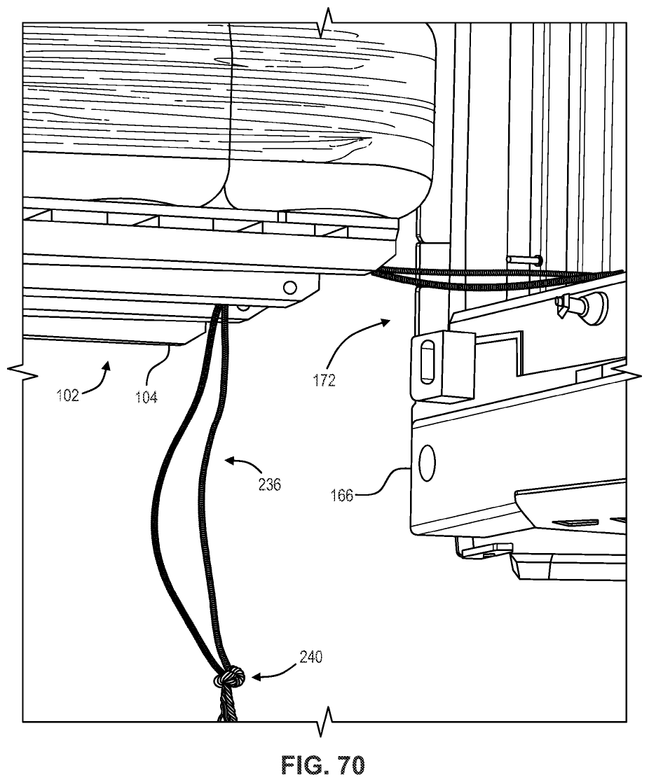

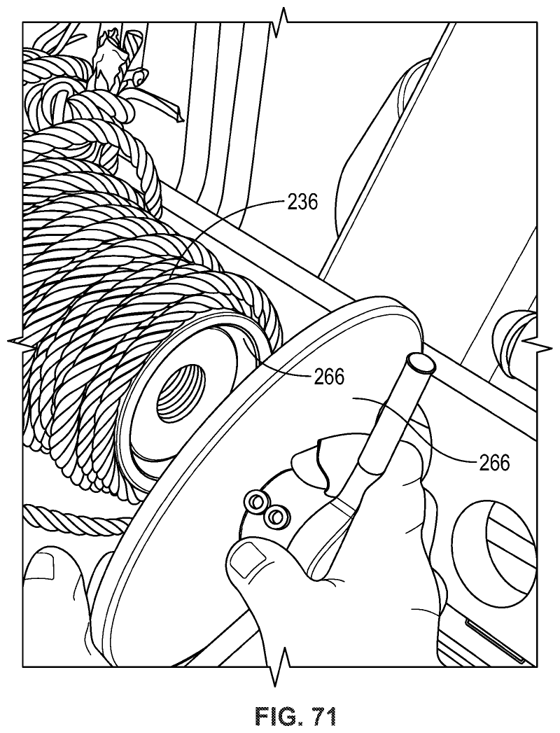

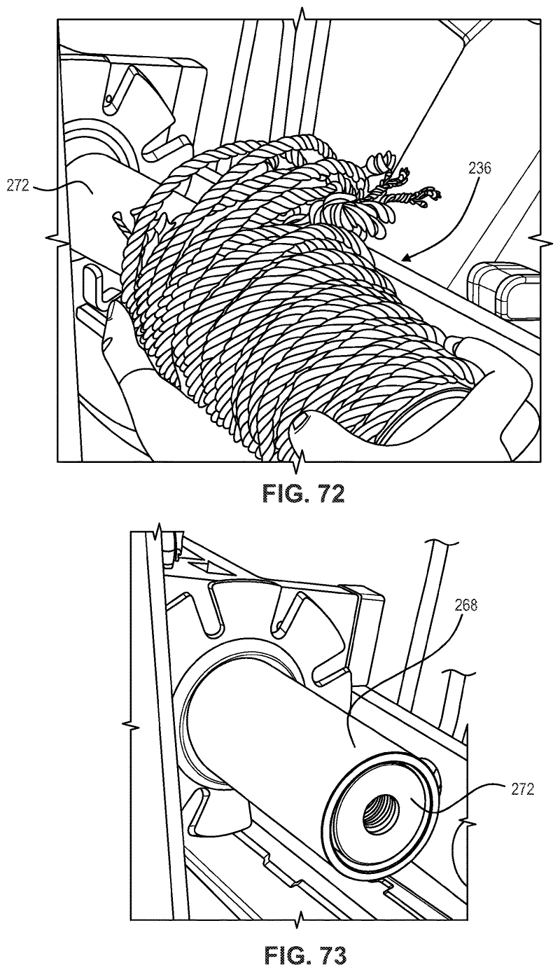

Referring to FIGS. 56 and 66, each base pallet 104 may include one or more medial sled rails 204b. At least one of those medial sled rails 204b may have a coupling aperture 226 therein. The coupling aperture 226 may be configured to have the securement end 238 of the respective extraction line 236 pass therethrough.

In particular preferred implementations of the system 100, the transport container 166 may be a cargo transport portion of a truck. Even more preferably, the transport container 166 may be a conventional 40 ft high-cube shipping container.

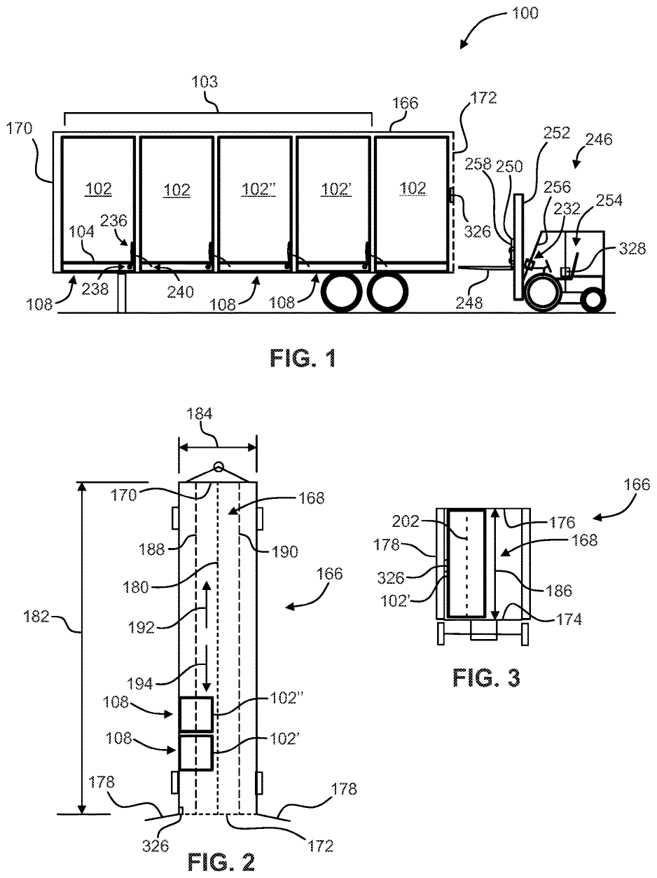

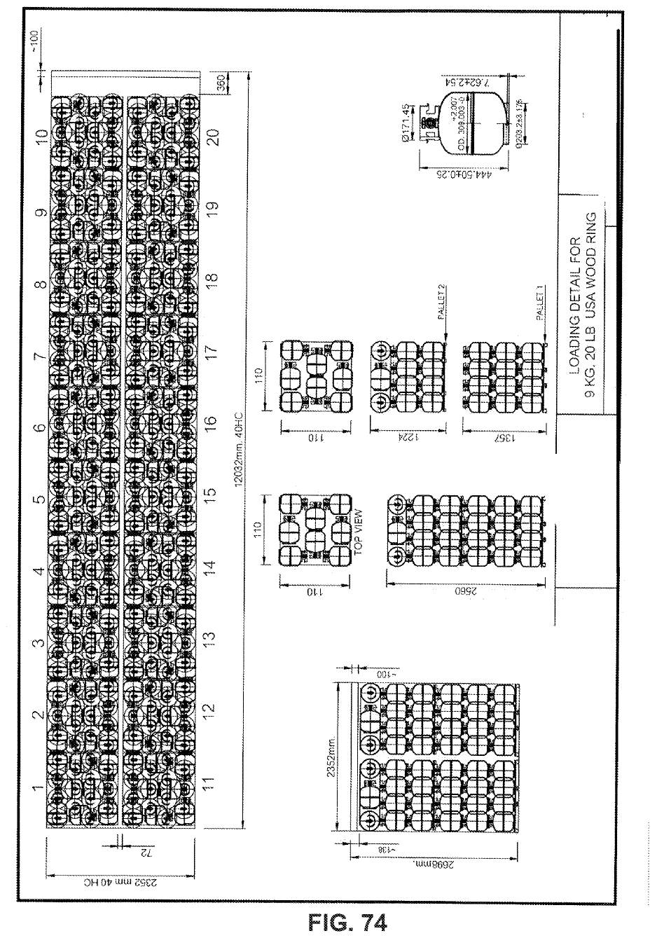

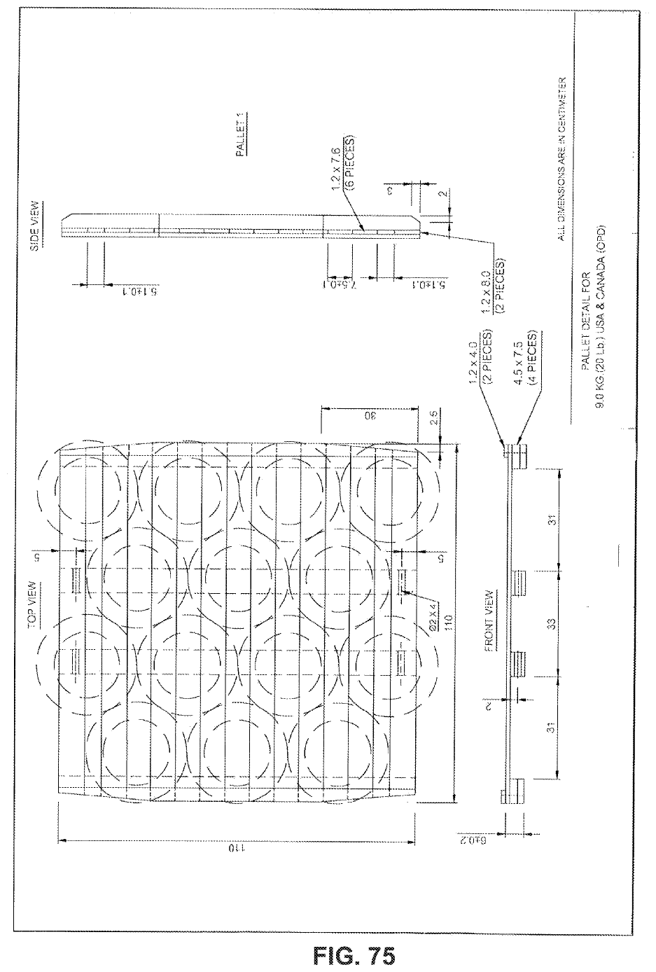

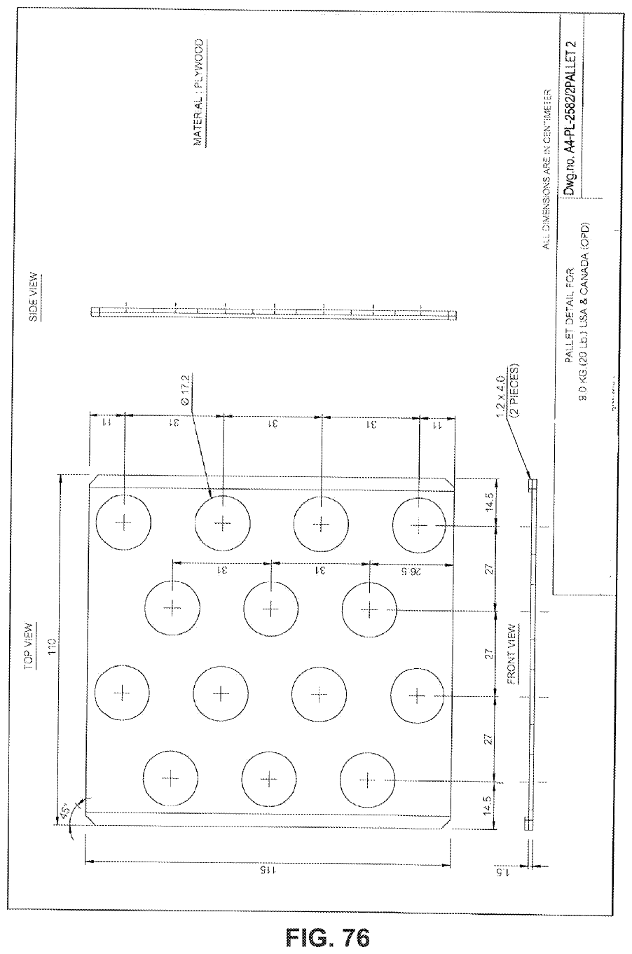

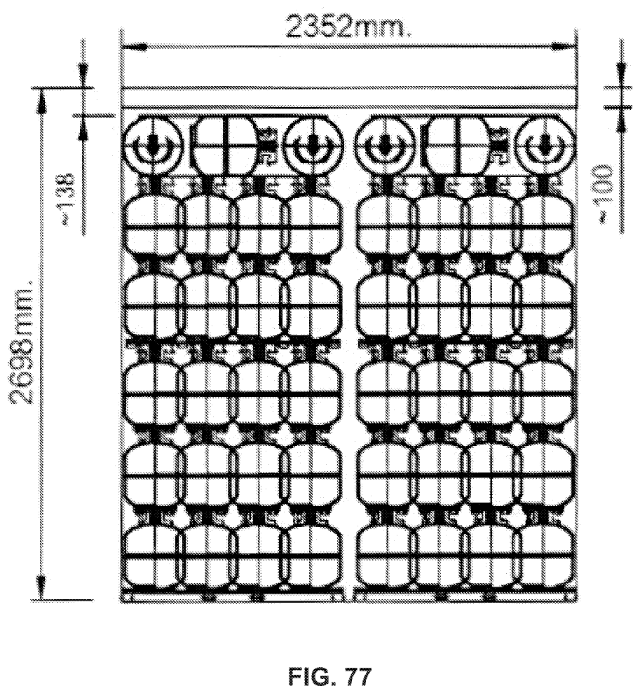

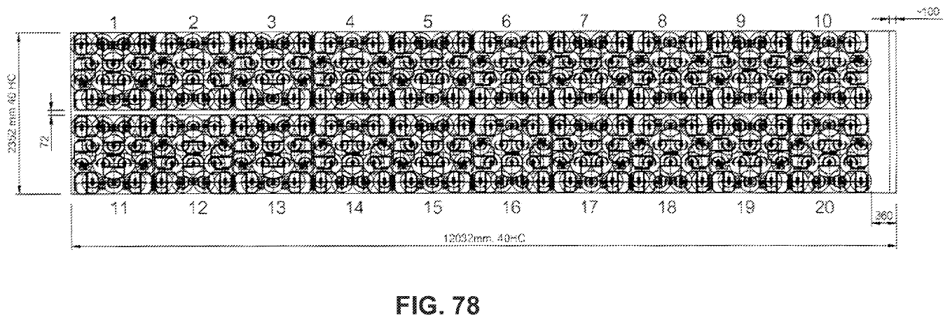

Referring to FIGS. 2, 22 and 74, certain preferred implementations of the system 100 may comprise a second set of palletized cargo units 102. The two sets may preferably be disposed laterally of and in parallel to one another within the transport container 166.

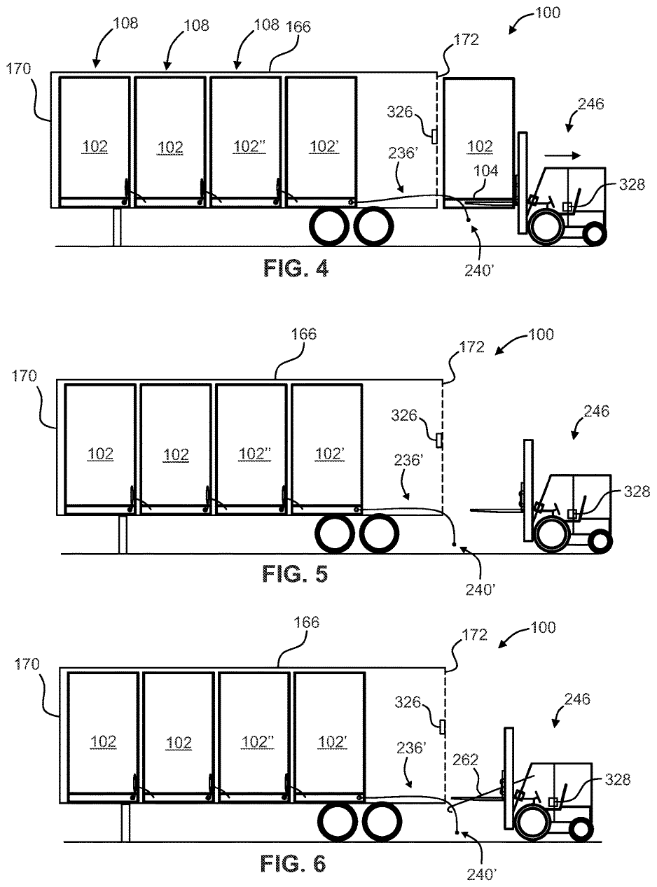

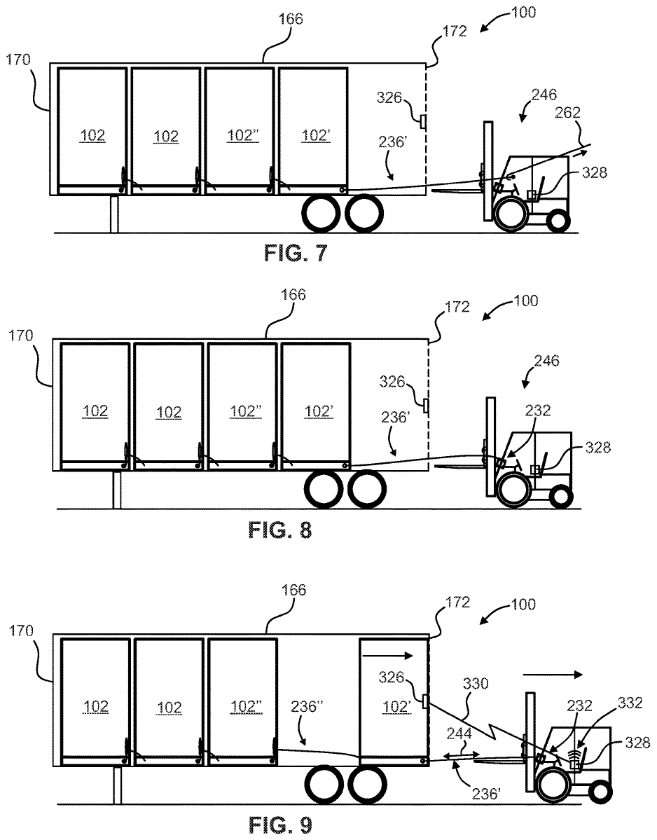

Referring to FIG. 23, the line securement element 232 may be a line catch affixed to the forklift 246. Referring to FIGS. 4-12, in such cases, for each palletized cargo unit 102 in the set, the line tension 244 may be configured to be applied by way of the forklift 246 moving away from the door threshold 172 with the terminal end 240 secured to the line catch 232.

Referring to FIGS. 8 and 9, certain implementations of the system 100 may further comprise a door threshold sensor 326 and a door threshold alarm unit 328. The door threshold sensor 326 may be affixed to the transport container 166 (e.g., at the door threshold 172) and configured to detect when a palletized cargo unit 102 reaches the door threshold 172 during the slidable pulling of that unit. The door threshold alarm unit 328 may be configured to receive a signal 330 from the door threshold sensor 326, and alert the forklift driver of the detection (e.g., by audio, visual or tactile alarm 332.

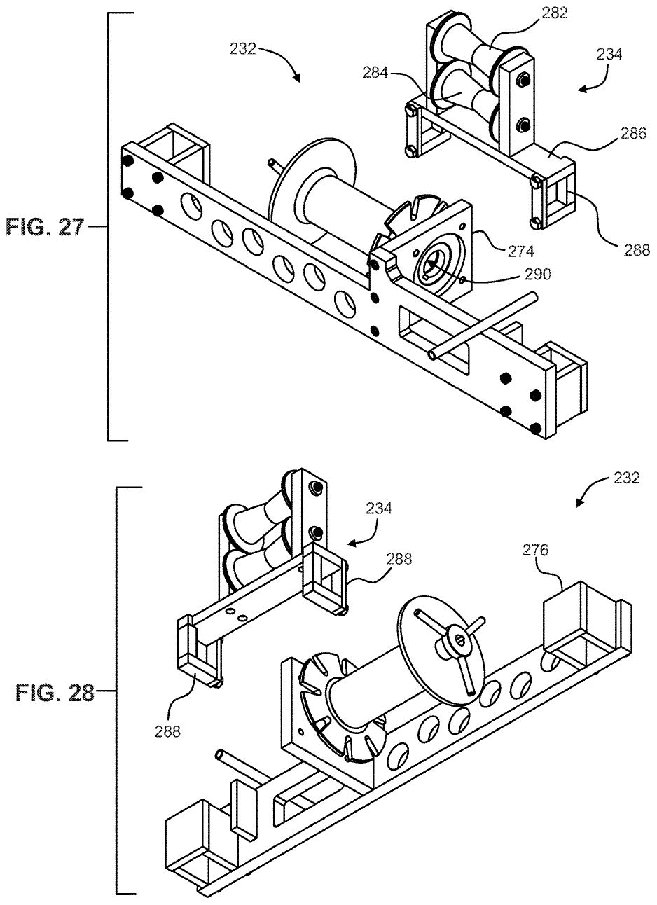

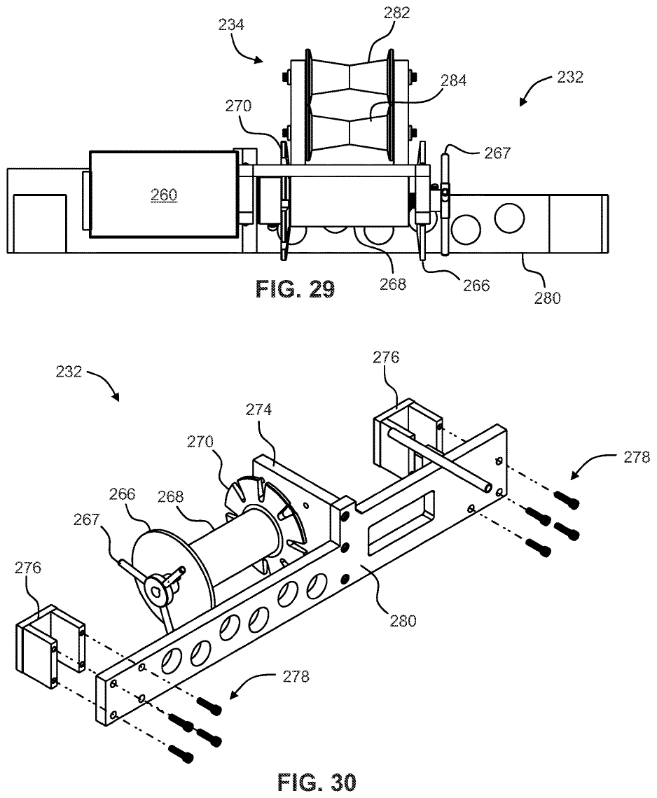

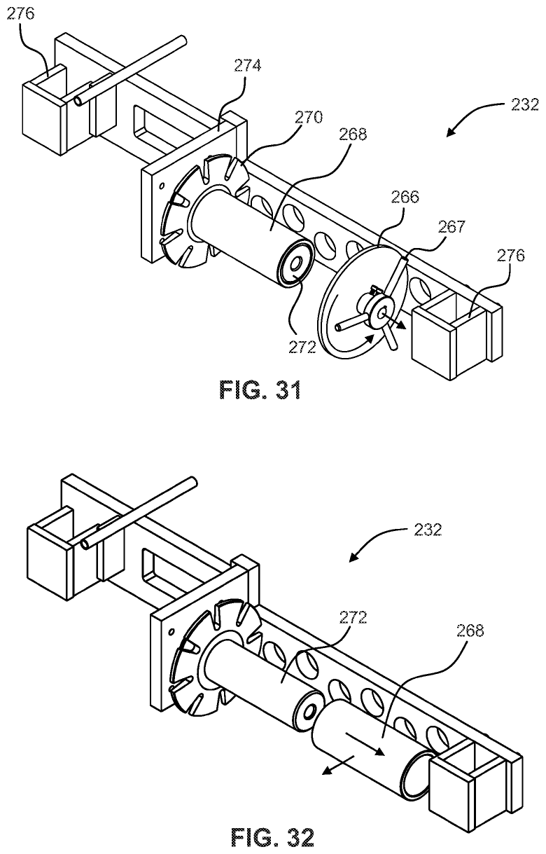

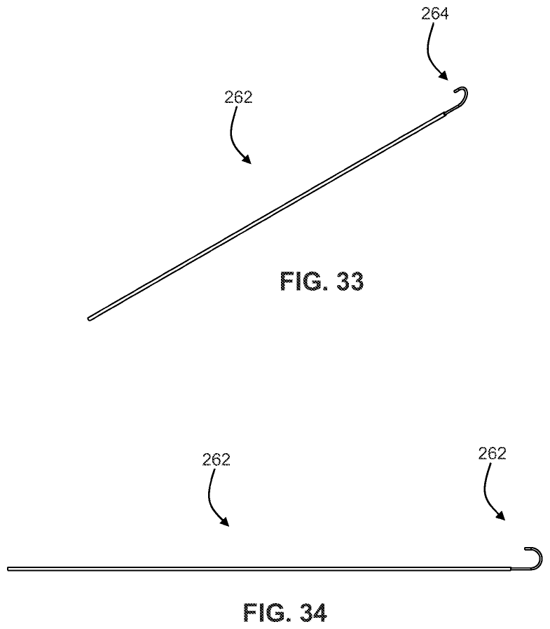

Referring to FIGS. 25-32, in particular implementations of the system 100, the line securement element 232 may be a pallet winch assembly affixed to the forklift 246. Referring to FIG. 18, in such case, for each palletized cargo unit 102 in the set, the line tension 244 may be configured to be applied by way of operation of the pallet winch assembly 232.

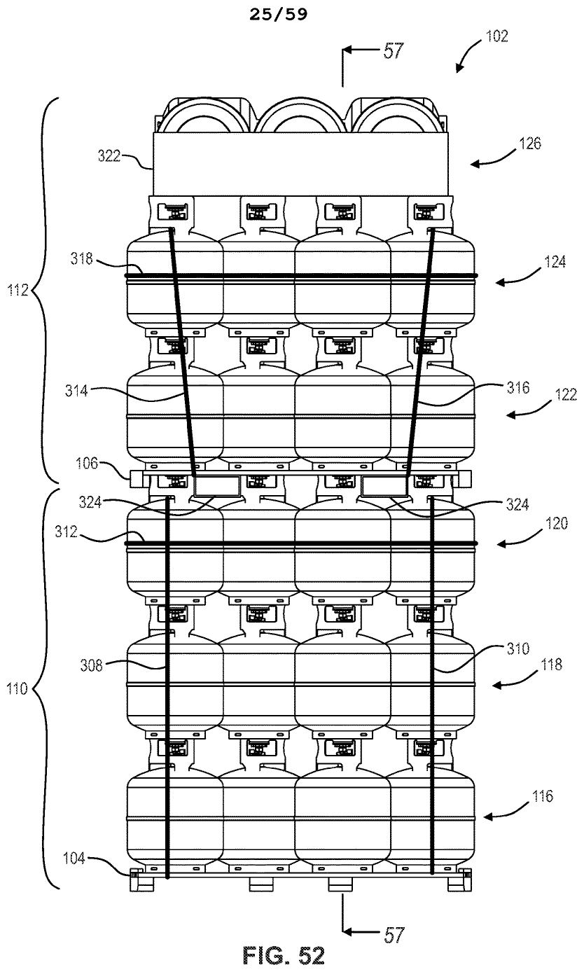

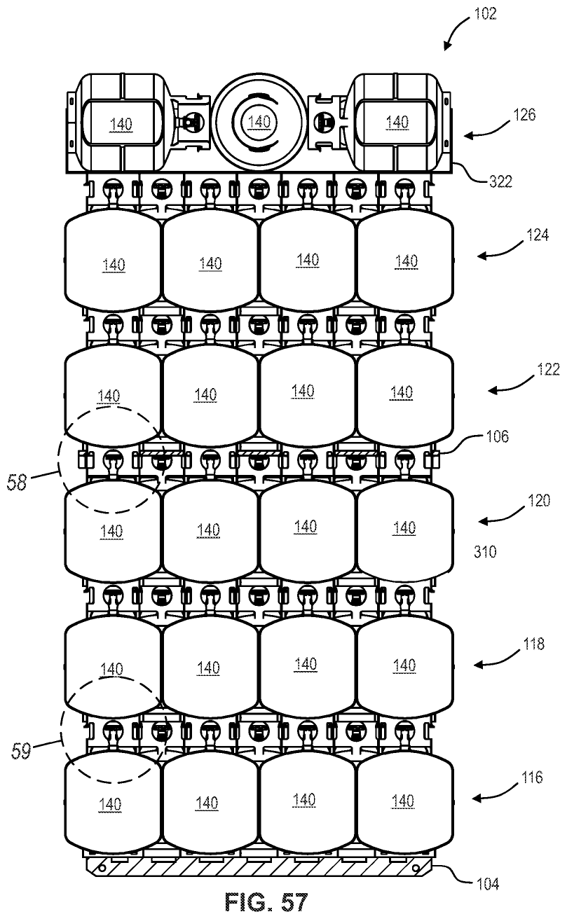

Referring to FIGS. 52 and 57, each palletized cargo unit 102 may comprise multiple stacked arrays of gas cylinders 140. For example, a palletized cargo unit 102 may preferably comprise (i) a first array 116 of gas cylinders; (ii) a second array 118 of gas cylinders disposed above the first array 116; (iii) a third array 120 of gas cylinders disposed above the second array 118; (iv) a fourth array 122 of gas cylinders disposed above the third array 120; and (v) a fifth array 124 of gas cylinders disposed above the fourth array 122.

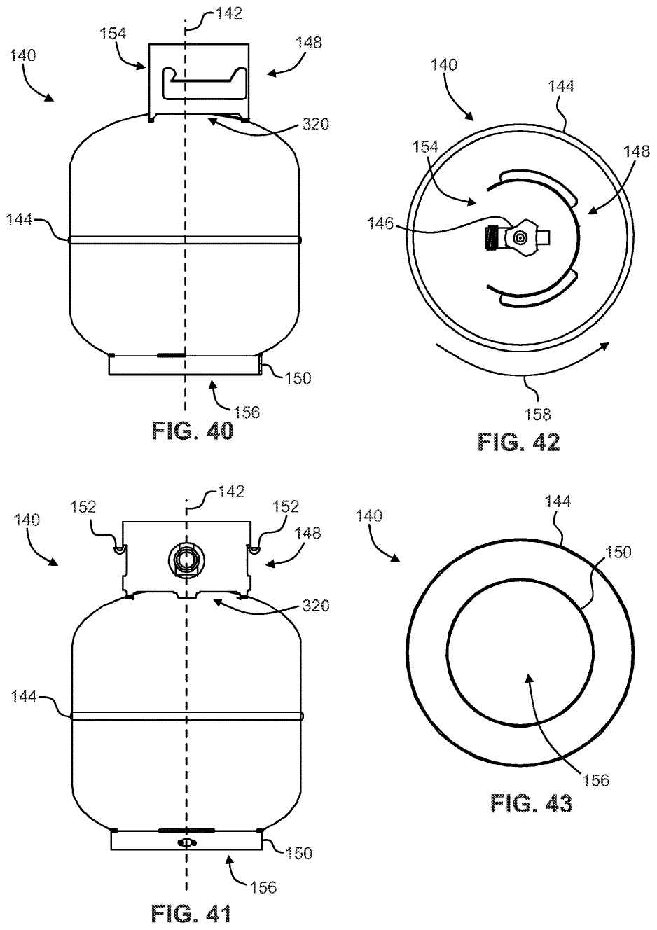

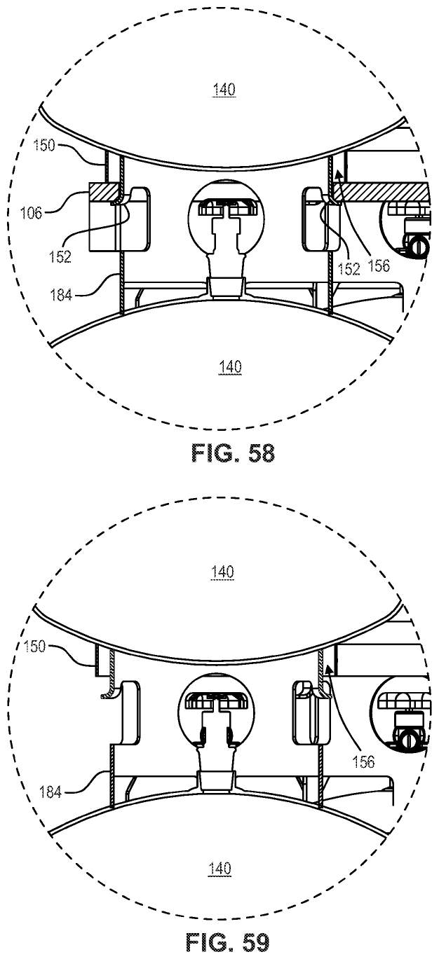

Referring to FIGS. 40, 43, each of the gas cylinders 140 may include a foot portion 150, a handle portion 148, and a tank main axis 142 extending from the foot portion 150 through the handle portion 148. Referring to FIGS. 57-59, for each of the first through fifth arrays (116, 118, 120, 122, 124) of gas cylinders 140, the handle portion 148 of each gas cylinder 140 in the array is preferably at least partially received by the foot portion 150 (e.g., within foot recess 156) of a corresponding one of the gas cylinders 140 in the array disposed thereabove.

Each palletized cargo unit 102 may preferably comprise an intermediate pallet 106. Referring to FIGS. 41 and 42, the intermediate pallet 106 may include a plurality of handle pass-through apertures 294. Referring to FIGS. 57-59, the handle portion 148 of each gas cylinder 140 in the third array 120 may preferably at least partially extend through a corresponding one of the handle pass-through apertures 294.

Referring to FIGS. 41 and 57-59, each handle portion 148 may preferably include one or more handle lips 152. In such case, the intermediate pallet 106 may preferably be vertically supported by the handle lips 152 of the gas cylinders 140 in the third array 120.

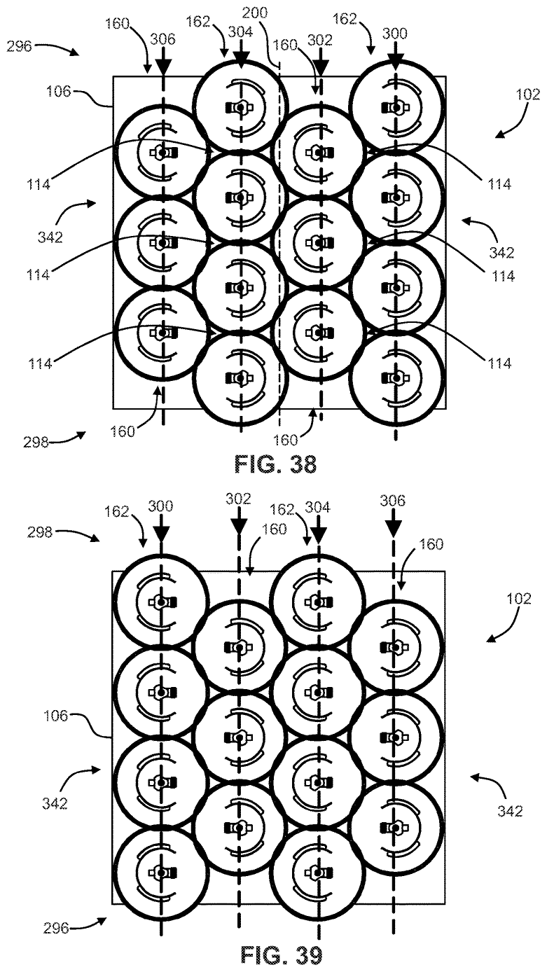

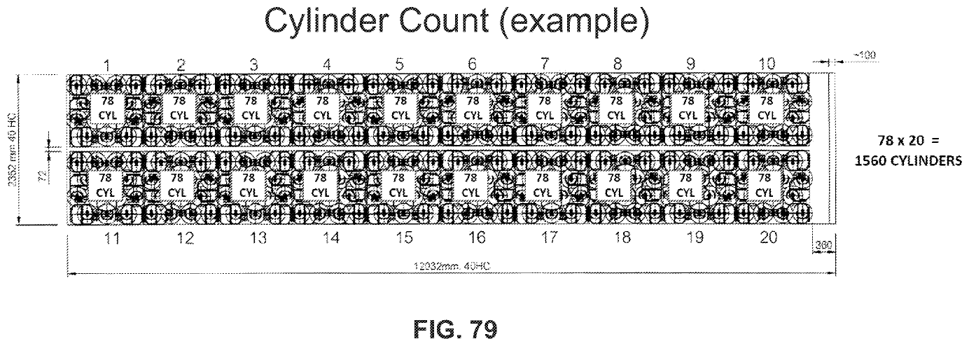

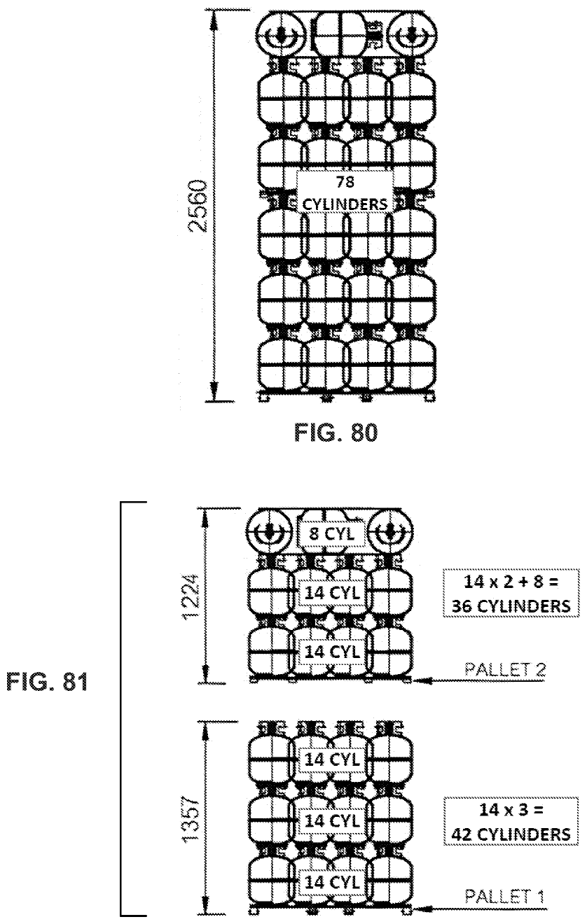

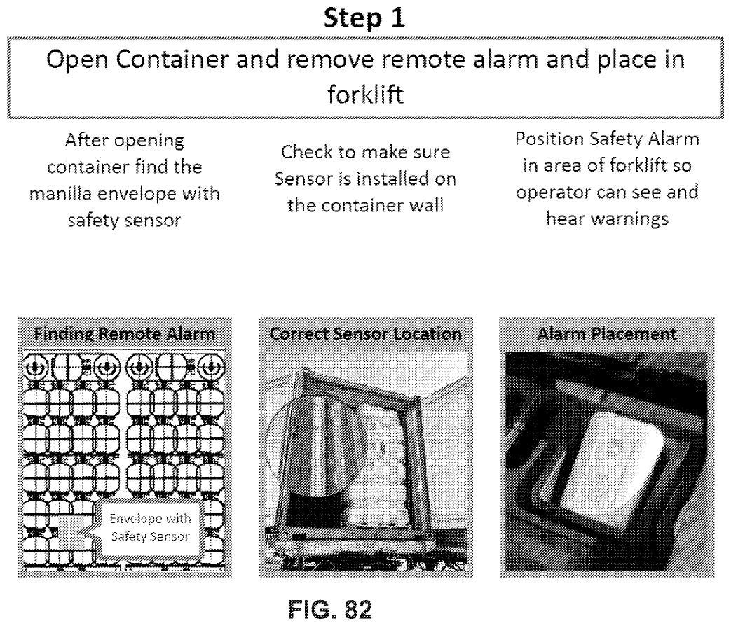

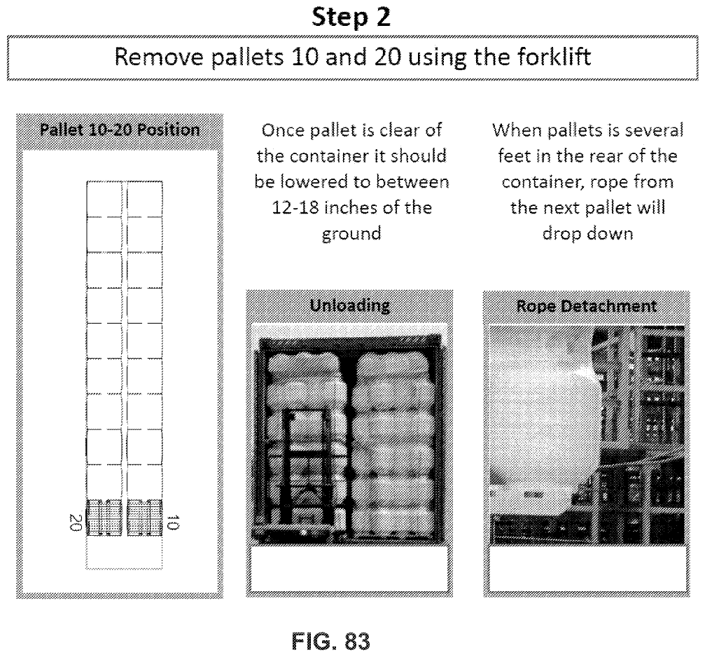

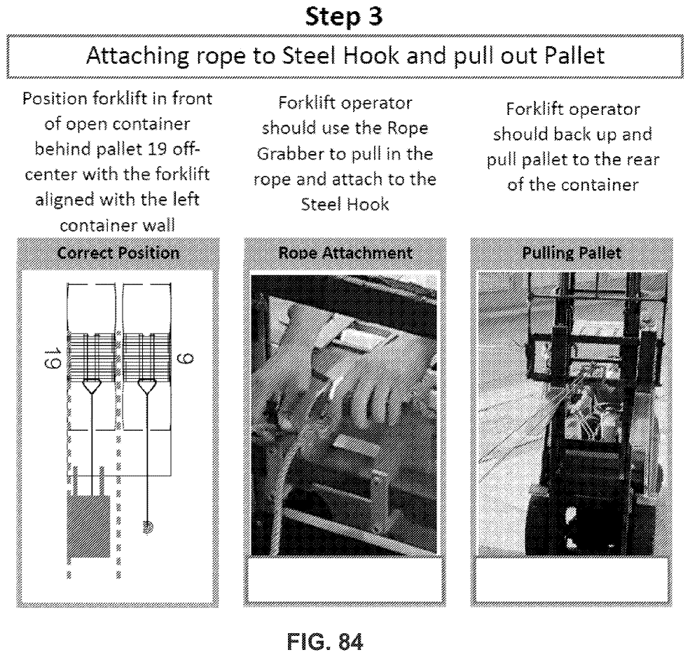

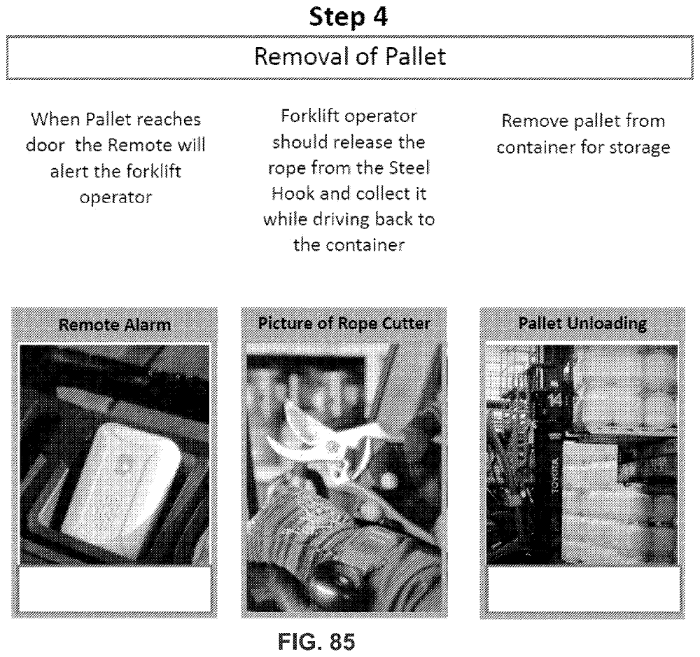

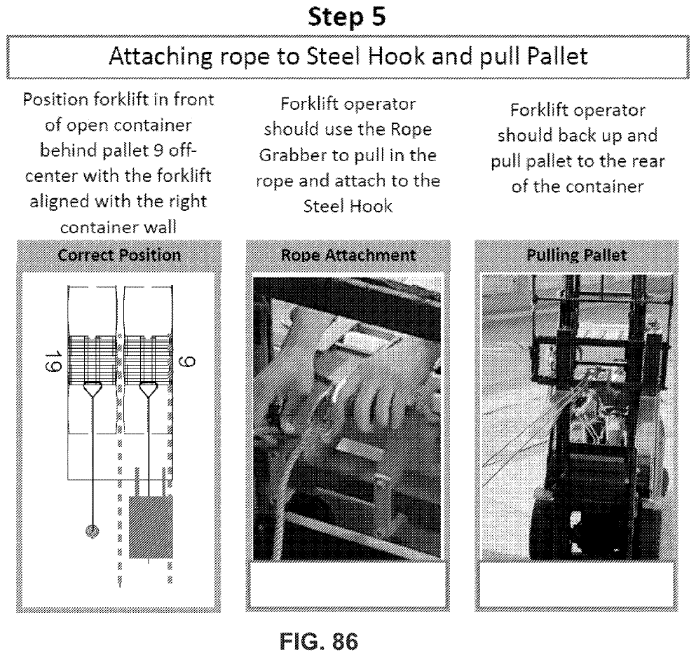

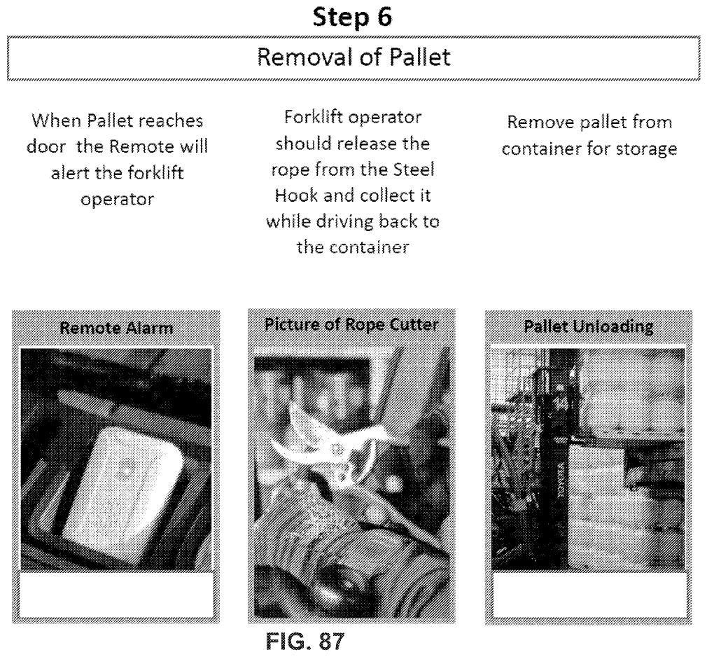

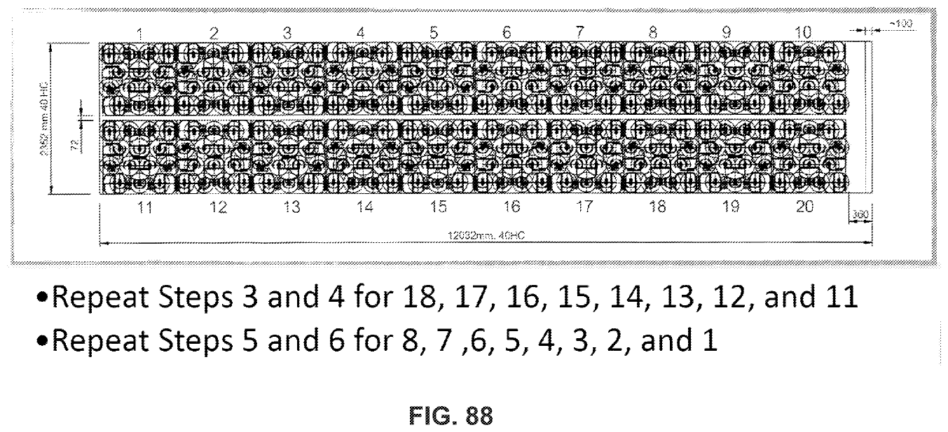

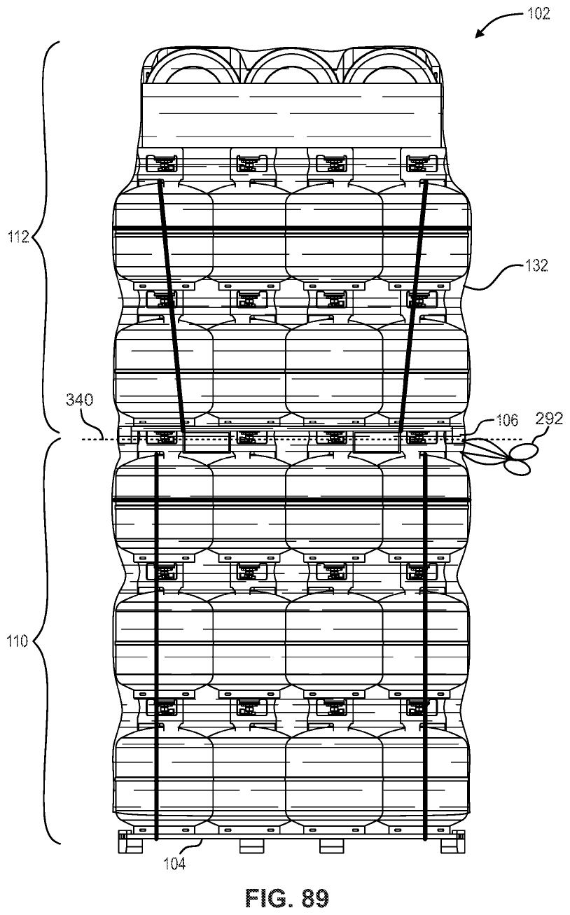

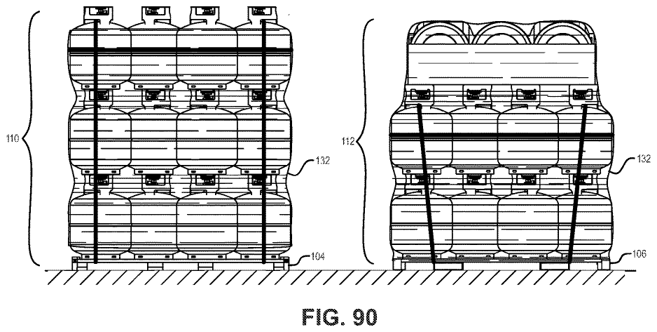

Referring to FIGS. 38 and 39, in certain preferred implementation of the system 100, each palletized cargo unit 102 may include. (i) a first engagement side 296 and a second engagement side 298 opposite thereof; (ii) a slide axis 200 extending from the first engagement side 296 to the second engagement side 298; and (iii) a pair of opposing lateral sides 342 disposed in parallel to the slide axis 200. In such case, in each palletized cargo unit 102, (i) each of the first though fifth array (116, 118, 120, 122, 124) may include four consecutive columns (300, 302, 304, 306) of gas cylinders 140 disposed in parallel to the slide axis 200. The first column 300 and third column 304 of each of the first through fifth array may include four gas cylinders 140, and the second column 302 and fourth column 306 of each of the first through fifth array may include three gas cylinders 140. Interstitial spaces 114 may be defined between the gas cylinders 140 in the first column 300 and third column 304. Each gas cylinder 140 in the second column 302 and the fourth column 306 may be partially received by one or more of the interstitial spaces 114. A pair of stack channels 160 and a pair of stack protrusions 162 may be alternatingly defined in the first engagement side 296 and the second engagement side 298. For each such palletized cargo unit 102, (i) the first engagement side 296 of the palletized cargo unit 102 may be in sequential engagement with the first engagement side 296 of a sequentially adjacent palletized cargo unit 102; or (ii) the second engagement side 298 of the palletized cargo unit 102 may be in sequential engagement with the second engagement side 298 of a sequentially adjacent palletized cargo unit 102 (see, e.g., FIG. 79). As a result of these configurations, for each adjacent pair of palletized cargo units 102, the sequential engagement may result in stack protrusions 162 of each of the palletized cargo unit 102 being received by stack channels 160 of the other palletized cargo unit 102.

Referring to FIGS. 40 and 42, the handle portion 148 of the gas cylinders 140 may include a relief gap 154. Referring to FIG. 35, in the third array 120, a pair of fork relief zones 136 may be defined in part by (i) the relief gaps 154 of the gas cylinders 140 in the first column 300 facing toward the second column 302; (ii) the relief gaps 154 of the gas cylinders 140 in the second column 302 facing toward the first column 300; (iii) the relief gaps 154 of the gas cylinders 140 in the third column facing toward the fourth column 306; and (iv) the relief gaps 154 of the gas cylinders 140 in the fourth column 306 facing toward the third column 304. Each fork relief zone 136 may be configured to receive a corresponding fork 136 of the forklift 246.

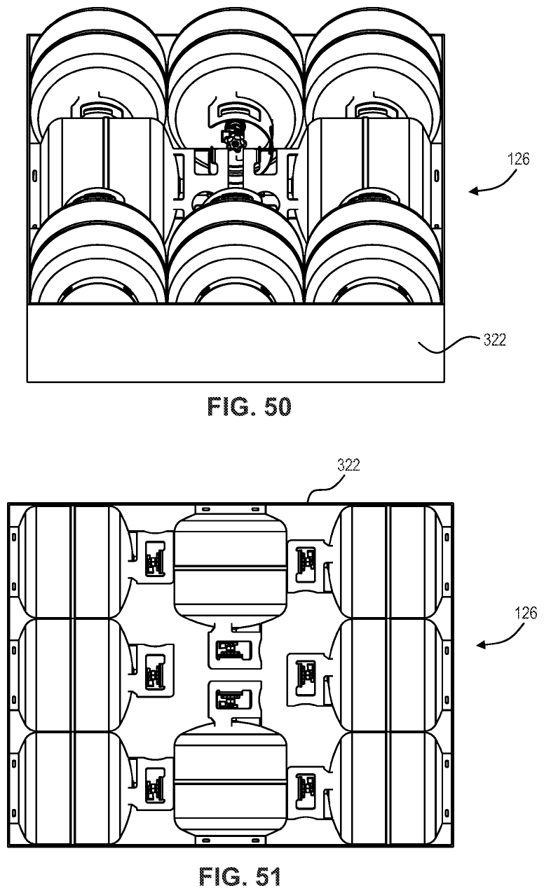

Referring to FIGS. 50-52, the palletized cargo units 102 may each comprise a sixth array 126 of gas cylinders 140. In such cases, the sixth array 126 may be disposed above the fifth array 124 and may include eight gas cylinders 140. The tank main axes 142 of the gas cylinders 140 in the sixth array 126 may be perpendicular to the tank main axes 142 of the gas cylinders 140 in the fifth array 124. The tank main axes 142 of two of the gas cylinders 140 in the sixth array 126 may be perpendicular to the tank main axes 142 of the other six gas cylinders 140 in the sixth array 126. The sixth array 126 may preferably be at least partially retained within a cardboard housing 322.

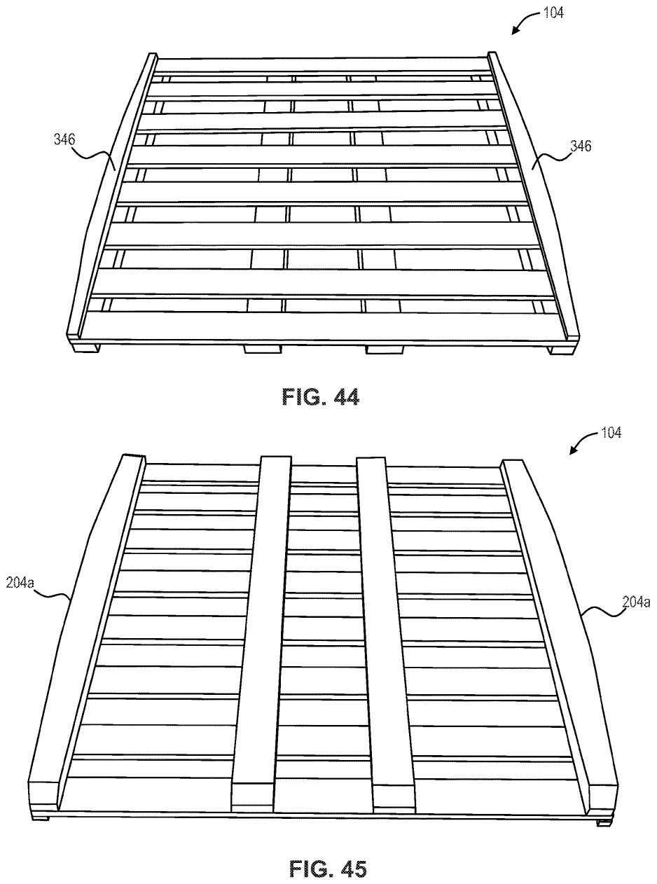

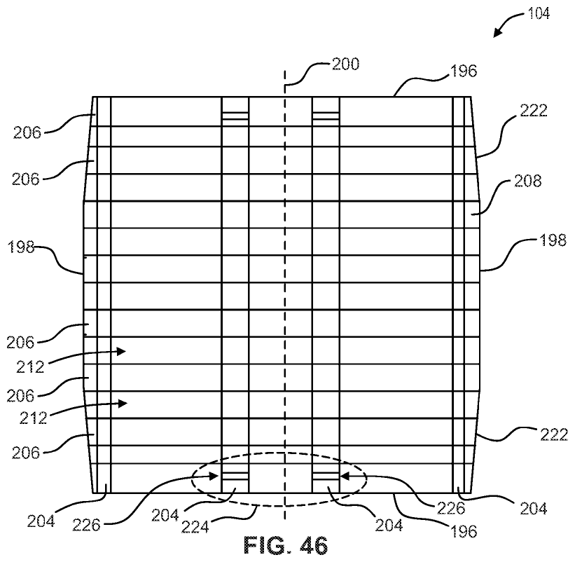

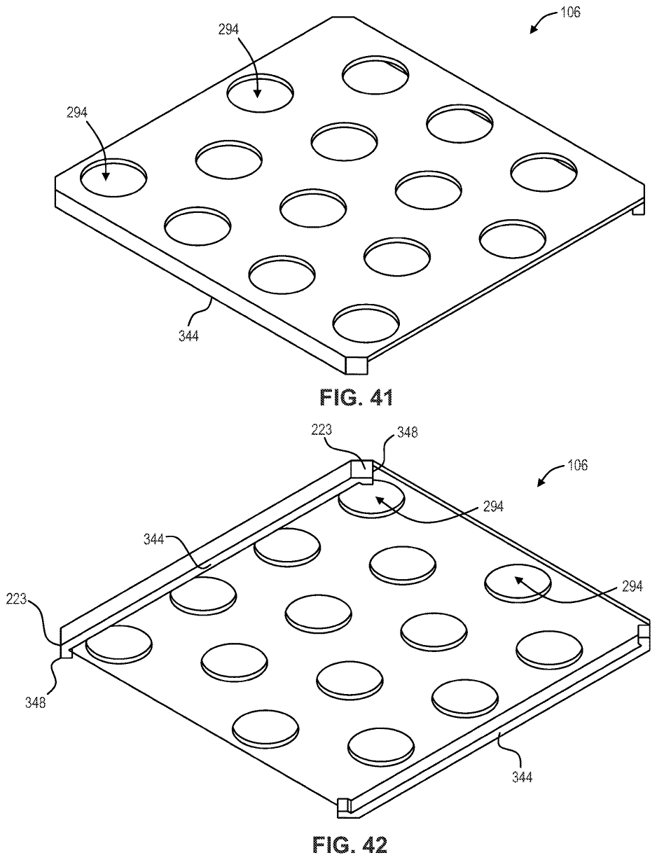

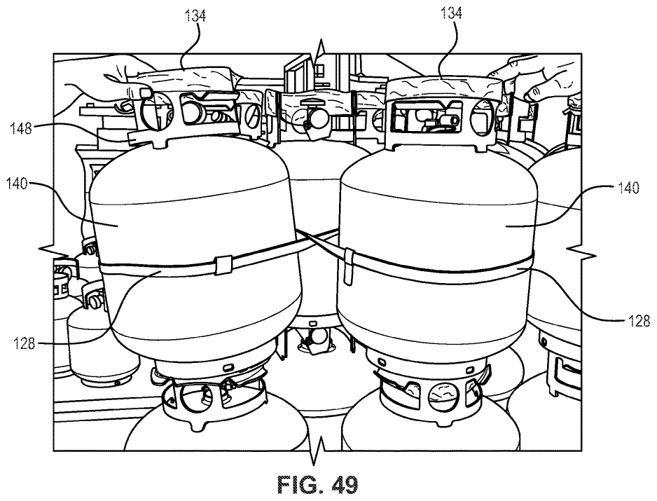

Referring to FIGS. 41 and 42, the intermediate pallet 106 may include a pair of handle retention lips 344 laterally opposed from one another. Referring to FIG. 44, the base pallet 104 may include a pair of foot retention lips 346 laterally opposed from one another.

Referring to FIGS. 40 and 41, in each gas cylinder 140, a strap aperture 320 may be defined at the handle portion 148. Referring to FIG. 52, in each palletized cargo unit 102, a lower cargo grouping 110 may be defined at least in part by the combination of the base pallet 104, and the first array 116, second array 118 and third array 120 of gas cylinders 140. An upper cargo grouping 112 may be defined at least in part by the combination of the intermediate pallet 106 and the fourth array 122, fifth array 124 and sixth array 126 of gas cylinders 140. In such embodiments of a palletized cargo unit 102, a first vertical securement strap 308 may extend in closed loop fashion through the base pallet 104 and through the strap apertures 320 of the gas cylinders 140 in the first column 300 of the third array 120. A second vertical securement strap 310 may extend in closed loop fashion through the base pallet 104 and through the strap apertures 320 of the gas cylinders 140 in the fourth column 306 of the third array 120. A first horizontal securement strap 312 may extend in closed loop fashion around the third array 120 (e.g., around the tank bodies or the handle portions in the third array 120). A third vertical securement strap 314 may extend in closed loop fashion under the intermediate pallet 106 and through the strap apertures 320 of the gas cylinders 140 in the first column 300 of the fifth array 124. A fourth vertical securement strap 316 may extend in closed loop fashion under the intermediate pallet 106 and through the strap apertures 320 of the gas cylinders 140 in the fourth column 306 of the fifth array 124. A second horizontal securement strap 318 may extend in closed loop fashion around the fifth array 124 (e.g., around the tank bodies or the handle portions in the fifth array 124).

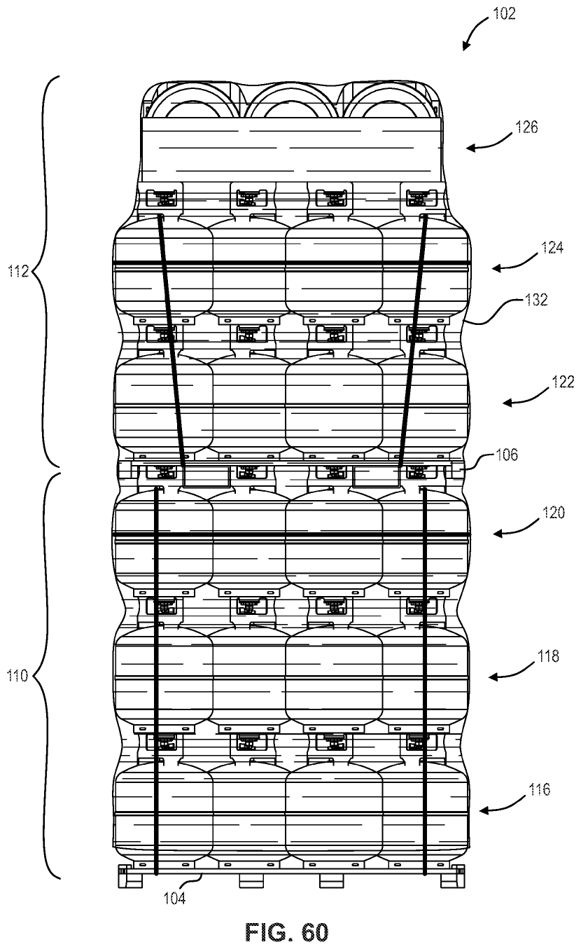

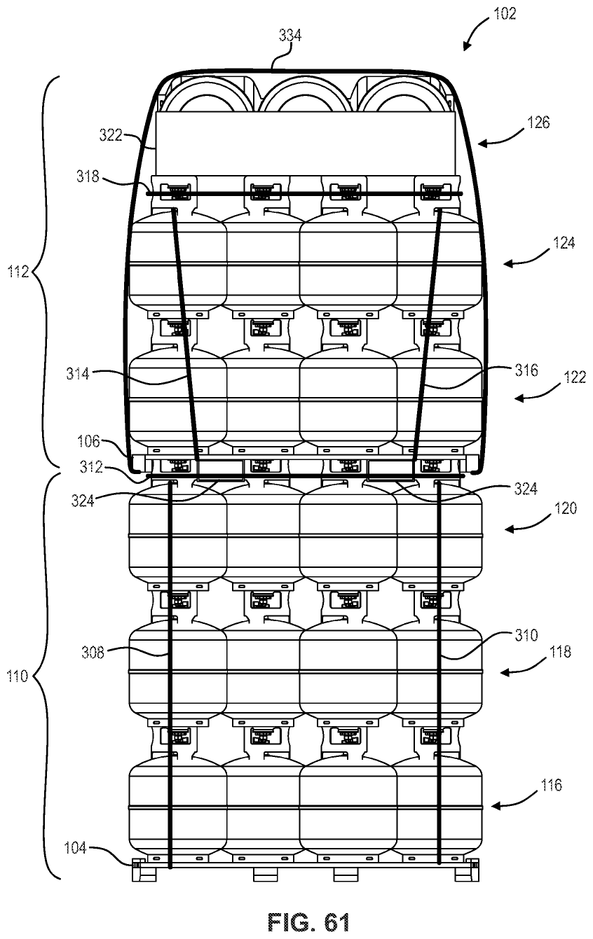

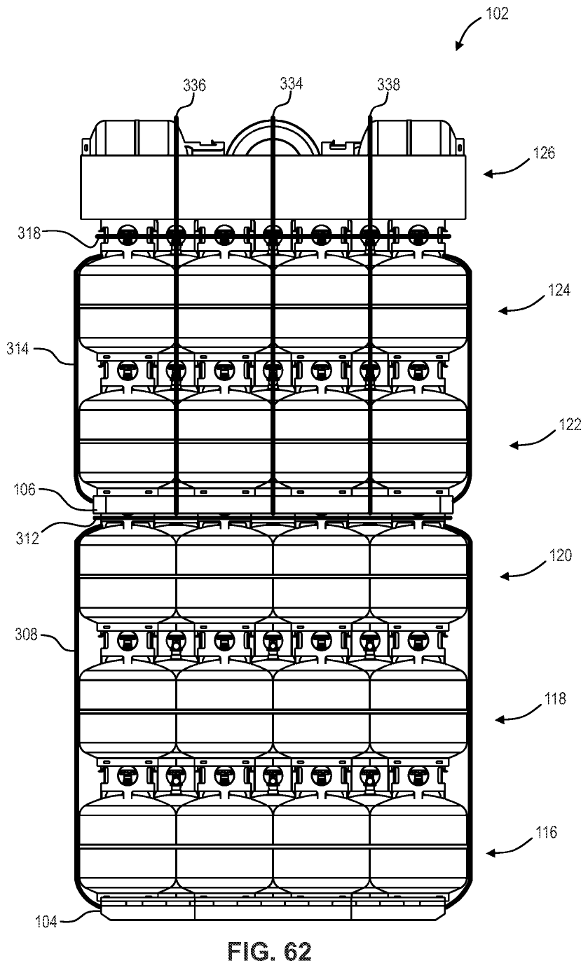

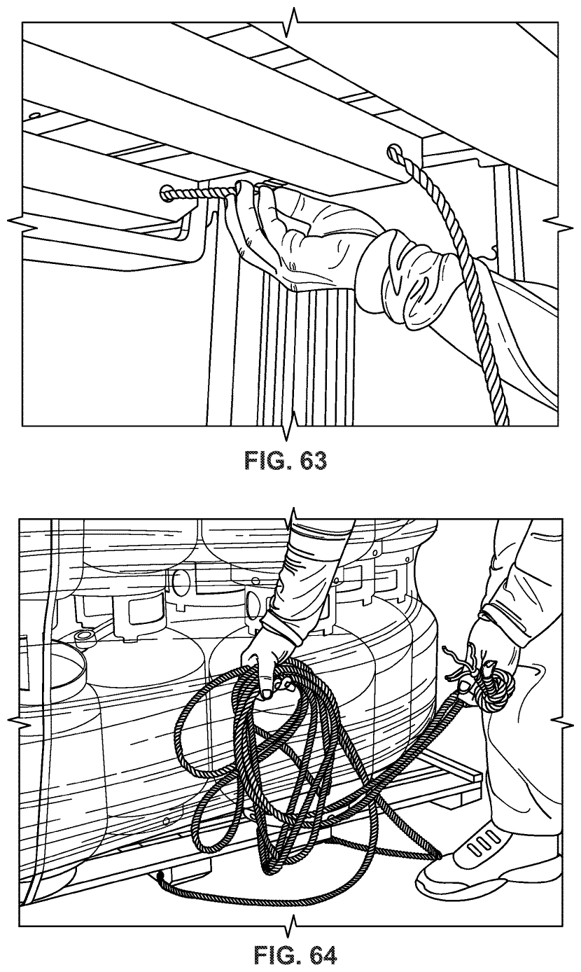

Referring to FIG. 60, each of the palletized cargo units 102 may include a plastic wrapping 132 enveloping and collectively securing most or all of the arrays of gas cylinders and the intermediate pallet 106.

Referring to FIG. 56, each base pallet 104 may include a pair of lateral sled rails 204a disposed apart from one another. Each lateral sled rail 204a may include opposing rail ends (214, 216). A deck interface surface 218 220 with vertical chamfers extending from the deck interface surface 218 to each rail end (214, 216). An outboard face 198 may be perpendicular to the deck interface surface 218 and may have base lateral chamfers 222 extending to each rail end (214, 216).

Referring to FIGS. 41 and 42, each handle retention lip 344 may include a pair of opposing handle retention lip ends 348, and intermediate lateral chamfers 223 at each of the handle retention lip ends 248.

Referring to FIG. 52, each palletized cargo unit 102 may include a pair of fork relief zone tubes 324 extending through a respective one of the fork relief zones 136. These tubes 324 may preferably comprise carboard or similar recyclable material, and may preferably be separate components from the intermediate pallet 106.

The following listing matches certain terminology used within this disclosure with corresponding reference numbers used in the non-limiting embodiments illustrated in the several figures.
100 system
102 palletized cargo unit (102′ is a preceding unit, and 102″ is a subsequent unit)
103 set of palletized cargo units
104 base pallet
106 intermediate pallet
108 transport position
110 lower cargo grouping
112 upper cargo grouping
114 interstitial spaces
116 first array (e.g., of gas cylinders) (e.g., first level)
118 second array (e.g., of gas cylinders) (e.g., second level)
120 third array (e.g., of gas cylinders) (e.g., third level)
122 fourth array (e.g., of gas cylinders (e.g., fourth level)
124 fifth array (e.g., of gas cylinders) (e.g., fifth level)
126 sixth array (e.g., of gas cylinders) (e.g., sixth level)
128 rubber band (e.g., connect four adjacent tanks together)
130 pallet strapping (e.g., polyester)
132 plastic wrap (e.g., enveloping palletized cargo unit)
134 handle protection layer (e.g., bubble wrap on tank handle)
136 fork relief zone (provided by tank handle orientation)
138 height of palletized cargo unit (e.g., 254 cm)
140 tank (e.g., gas cylinder; e.g., liquid propane cylinder)
142 tank main axis
144 circumferential perimeter (of tank)
146 valve
148 handle portion (of tank)
150 foot portion (of tank; e.g., annular)
152 handle lip (e.g., handle grip)
154 relief gap (e.g., valve relief gap (e.g., “flat” portion lateral of handle))
156 foot recess (e.g., in bottom of foot portion)
158 tank rotational direction
160 stack channel (formed by inwardly disposed stack of gas cylinders)
162 stack protrusion (formed by outwardly-protruding gas cylinders)
164 cargo load
166 transport container (e.g., semi-trailer; cargo container)
168 cargo compartment
170 closed end
172 door threshold
174 floor (deck)
176 ceiling
178 door (e.g., rear door)
180 compartment main axis
182 compartment length
184 compartment width
186 compartment height
188 first transfer axis
190 second transfer axis (e.g., lateral and parallel to the first transfer axis)
192 insertion direction
194 extraction direction
196 longitudinal periphery (of base pallet)
198 lateral periphery (of base pallet; outboard face)
200 slide axis (of base pallet)
202 load axis (of base pallet; e.g., load vertical axis)
204a lateral sled rails (of base pallet)
204b medial sled rails (of base pallet)
206 cross brace (of pallet; e.g., orthogonal to rails)
208 foot retention lip (e.g., lateral guide (e.g., to prevent foot of tank from sliding laterally on base pallet)
210 rail gaps (between adjacent rails)
212 brace gaps (between adjacent cross braces)
214 first end (of sled rail)
216 second end (of sled rail)
218 deck interface surface (of sled rail)
220 vertical chamfer (of sled rail)
222 base lateral chamfer (of base pallet)
223 intermediate lateral chamfer (of intermediate pallet)
224 coupling portion (e.g., line coupling portion of base pallet)
226 coupling aperture (e.g., line pass-through aperture)
228 pallet length (e.g., 110 cm)
230 pallet width (e.g., 110 cm)
232 line securement element (e.g., pallet winch assembly or line hook on forklift)
234 winch line guide assembly
236 extraction line (e.g., rope or cable, e.g., winch line)
238 securement end (e.g., pallet securement end of extraction line, e.g. loop portion)
239 loop portion (e.g., of rope)
240 terminal end (e.g., winch connection end of winch line; e.g., knot)
241 rope ends
242 extended length (of extension line)
244 line tension
246 forklift
248 fork
250 carriage
252 mast
254 operator cab
256 frame uprights
258 load backrest (cargo rests against this once forks are fully inserted into pallet)
260 winch motor (e.g., hydraulic)
262 extraction line retrieval staff (e.g., winch line retrieval staff, e.g., with hook)
264 hook on retrieval staff
266 spool retention flange
267 flange torsion handle
268 line sleeve
270 line securement flange
272 winch axle
274 motor interface mounting bracket
276 winch assembly mounting bracket
278 bracket fasteners (e.g., bolts)
280 winch assembly frame
282 upper guide roller
284 lower guide roller
286 winch line guide frame
288 guide mounting bracket
290 motor interface
292 cutting device (e.g., knife or sheers)
294 handle pass-through apertures
296 first engagement side
298 second engagement side
300 first column
302 second column
304 third column
306 fourth column
308 first vertical securement strap
310 second vertical securement strap
312 first horizontal securement strap
314 third vertical securement strap
316 fourth vertical securement strap
318 second horizontal securement strap
320 strap aperture
322 housing (e.g., cardboard)
324 fork relief zone tube
326 door threshold sensor
328 door threshold alarm unit (e.g., wirelessly coupled to the door threshold sensor)
330 signal
332 alarm (e.g., audio or visual)
334 fifth vertical securement strap
336 sixth vertical securement strap
338 seventh vertical securement strap
340 plastic wrap cut line
342 lateral side
344 handle retention lip
346 foot retention lip
348 lip ends

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

1-3. (canceled)

4: A system for unloading palletized cargo units from a transport container by way of a forklift, the system comprising:
a set of palletized cargo units in a sequential arrangement along a transfer axis within the transport container, the transfer axis extending from a closed end of the transport container to a door threshold of the transport container, each palletized cargo unit in the set having
(a) a transport position within the sequential arrangement;
(b) a base pallet on which a cargo load is supported, the base pallet being configured to receive forks of the forklift when the base pallet is at the door threshold; and
(c) an extraction line
(i) having a securement end and a terminal end, the securement end being coupled to the base pallet;
(ii) being reconfigurable between a bundled configuration and an extended configuration; and
(iii) having an extended length when in the extended configuration, the extended length being sufficient to enable the terminal end to extend outward of the door threshold when the palletized cargo unit is in the transport position;
wherein
(a) for each of the palletized cargo units in the set, the base pallet is slidably pullable toward the door threshold away from the closed end by way of line tension applied to the extraction line; and
(b) the line tension is configured to be applied by way of a line securement element of the forklift;
wherein for the set of palletized cargo units
for each subsequent palletized cargo unit having a preceding palletized cargo unit sequentially disposed closer to the door threshold, the terminal end of the extraction line of the subsequent palletized cargo unit is draggably attached to the preceding palletized cargo unit;
wherein the draggable attachment is configured to cause the terminal end of the extraction line of the subsequent palletized cargo unit to be dragged through the door threshold by way of
(a) the slidable pulling of the base pallet of the preceding palletized cargo unit; and
(b) removal of the preceding palletized cargo unit from the transport container by the forklift; and
wherein for each subsequent palletized cargo unit having a preceding palletized cargo unit sequentially disposed closer to the door threshold,
(a) the extraction line of the subsequent palletized cargo unit is the bundled configuration, and
(b) the draggable attachment is configured to allow the extraction line of the subsequent palletized cargo unit to gradually convert from the bundled configuration to the extended configuration during
(i) the slidable pulling of the base pallet of the preceding palletized cargo unit, and
(ii) removal of the preceding palletized cargo unit from the transport container by the forklift.

5: The system of claim 4, wherein, for each of the subsequent palletized cargo units, the draggable attachment of the extraction line to the preceding palletized cargo unit is configured to fully release upon the preceding palletized cargo unit being moved away from the transport container by the forklift.

6: The system of claim 5, wherein each extraction line is comprised of a single segment of rope with opposing rope ends, the terminal end of the extraction line being defined by a joining of the rope ends, the securement end of the extraction line being defined by a loop portion of the rope disposed between the rope ends.

7: A system for unloading palletized cargo units from a transport container by way of a forklift, the system comprising:
a set of palletized cargo units in a sequential arrangement along a transfer axis within the transport container, the transfer axis extending from a closed end of the transport container to a door threshold of the transport container, each palletized cargo unit in the set having
(a) a transport position within the sequential arrangement;
(b) a base pallet on which a cargo load is supported, the base pallet being configured to receive forks of the forklift when the base pallet is at the door threshold; and
(c) an extraction line
(i) having a securement end and a terminal end, the securement end being coupled to the base pallet;
(ii) being reconfigurable between a bundled configuration and an extended configuration; and
(iii) having an extended length when in the extended configuration, the extended length being sufficient to enable the terminal end to extend outward of the door threshold when the palletized cargo unit is in the transport position;
wherein
(a) for each of the palletized cargo units in the set, the base pallet is slidably pullable toward the door threshold away from the closed end by way of line tension applied to the extraction line; and
(b) the line tension is configured to be applied by way of a line securement element of the forklift;
wherein for the set of palletized cargo units
for each subsequent palletized cargo unit having a preceding palletized cargo unit sequentially disposed closer to the door threshold, the terminal end of the extraction line of the subsequent palletized cargo unit is draggably attached to the preceding palletized cargo unit;
wherein the draggable attachment is configured to cause the terminal end of the extraction line of the subsequent palletized cargo unit to be dragged through the door threshold by way of
(a) the slidable pulling of the base pallet of the preceding palletized cargo unit; and
(b) removal of the preceding palletized cargo unit from the transport container by the forklift; and
wherein for each subsequent palletized cargo unit having a preceding palletized cargo unit sequentially disposed closer to the door threshold, most of the extraction line of the subsequent palletized cargo unit is releasably attached to the subsequent palletized cargo unit when the extraction line is in the bundled configuration.

8: The system of claim 6, wherein the joining of the rope ends is by way of a knot.

9: The system of claim 8, wherein for each palletized cargo unit in the set, the coupling of the securement end to the base pallet is configured to be released by cutting the rope and pulling the extraction line away from the base pallet.

10: A system for unloading palletized cargo units from a transport container by way of a forklift, the system comprising:
a set of palletized cargo units in a sequential arrangement along a transfer axis within the transport container, the transfer axis extending from a closed end of the transport container to a door threshold of the transport container, each palletized cargo unit in the set having
(a) a transport position within the sequential arrangement;
(b) a base pallet on which a cargo load is supported, the base pallet being configured to receive forks of the forklift when the base pallet is at the door threshold; and
(c) an extraction line
(i) having a securement end and a terminal end, the securement end being coupled to the base pallet;
(ii) being reconfigurable between a bundled configuration and an extended configuration; and
(iii) having an extended length when in the extended configuration, the extended length being sufficient to enable the terminal end to extend outward of the door threshold when the palletized cargo unit is in the transport position;
wherein
(a) for each of the palletized cargo units in the set, the base pallet is slidably pullable toward the door threshold away from the closed end by way of line tension applied to the extraction line; and
(b) the line tension is configured to be applied by way of a line securement element of the forklift; and
wherein each base pallet includes one or more medial sled rails having a coupling aperture therein, the coupling aperture being configured to have the securement end of the respective extraction line pass therethrough.

11-13. (canceled)

14: A system for unloading palletized cargo units from a transport container by way of a forklift, the system comprising:
a set of palletized cargo units in a sequential arrangement along a transfer axis within the transport container, the transfer axis extending from a closed end of the transport container to a door threshold of the transport container, each palletized cargo unit in the set having
(a) a transport position within the sequential arrangement;
(b) a base pallet on which a cargo load is supported, the base pallet being configured to receive forks of the forklift when the base pallet is at the door threshold; and
(c) an extraction line
(i) having a securement end and a terminal end, the securement end being coupled to the base pallet;
(ii) being reconfigurable between a bundled configuration and an extended configuration; and
(iii) having an extended length when in the extended configuration, the extended length being sufficient to enable the terminal end to extend outward of the door threshold when the palletized cargo unit is in the transport position;
wherein
(a) for each of the palletized cargo units in the set, the base pallet is slidably pullable toward the door threshold away from the closed end by way of line tension applied to the extraction line; and
(b) the line tension is configured to be applied by way of a line securement element of the forklift;
wherein
(a) the line securement element is a line catch affixed to the forklift; and
(b) for each palletized cargo unit in the set, the line tension is configured to be applied by way of the forklift moving away from the door threshold with the terminal end secured to the line catch; and
wherein the system further comprises
(a) a door threshold sensor affixed to the transport container and configured to detect when a said palletized cargo unit reaches the door threshold during the slidable pulling; and
(b) a door threshold alarm unit configured to alert the forklift driver of the detection.

15-16. (canceled)

17: A system for unloading palletized cargo units from a transport container by way of a forklift, the system comprising:
a set of palletized cargo units in a sequential arrangement along a transfer axis within the transport container, the transfer axis extending from a closed end of the transport container to a door threshold of the transport container, each palletized cargo unit in the set having
(a) a transport position within the sequential arrangement;
(b) a base pallet on which a cargo load is supported, the base pallet being configured to receive forks of the forklift when the base pallet is at the door threshold; and
(c) an extraction line
(i) having a securement end and a terminal end, the securement end being coupled to the base pallet;
(ii) being reconfigurable between a bundled configuration and an extended configuration; and
(iii) having an extended length when in the extended configuration, the extended length being sufficient to enable the terminal end to extend outward of the door threshold when the palletized cargo unit is in the transport position;
wherein
(a) for each of the palletized cargo units in the set, the base pallet is slidably pullable toward the door threshold away from the closed end by way of line tension applied to the extraction line; and
(b) the line tension is configured to be applied by way of a line securement element of the forklift;
wherein
(a) each palletized cargo unit comprises:
(i) a first array of gas cylinders;
(ii) a second array of gas cylinders disposed above the first array of gas cylinders;
(iii) a third array of gas cylinders disposed above the second array of gas cylinders;
(iv) a fourth array of gas cylinders disposed above the third array of gas cylinders; and
(v) a fifth array of gas cylinders disposed above the fourth array of gas cylinders;
(b) each of the gas cylinders includes a foot portion, a handle portion, and a tank main axis extending from the foot portion through the handle portion; and
(c) for each of the first, second, third and fourth arrays of gas cylinders, the handle portion of each gas cylinder in the array is at least partially received by the foot portion of a corresponding one of the gas cylinders in the array disposed thereabove; and
wherein
(a) each palletized cargo unit comprises an intermediate pallet, the intermediate pallet includes a plurality of handle pass-through apertures;
and
(b) the handle portion of each gas cylinder in the third array at least partially extends through a corresponding one of the handle pass-through apertures.

18: The system of claim 17, wherein
(a) each handle portion includes one or more handle lips; and
(b) the intermediate pallet is vertically supported by the handle lips of the gas cylinders in the third array.

19: The system of claim 18, wherein
(a) each palletized cargo unit includes
(i) a first engagement side and a second engagement side opposite thereof;
(ii) a slide axis extending from the first engagement side to the second engagement side; and
(iii) a pair of opposing lateral sides disposed in parallel to the slide axis; and
(b) in each palletized cargo unit
(i) each of the first through the fifth array includes four consecutive columns of gas cylinders disposed in parallel to the slide axis; and
(ii) the first and third column of each of the first through fifth array includes four gas cylinders, and the second and fourth column of each array includes three gas cylinders;
(iii) interstitial spaces are defined between the gas cylinders in the first and third columns;
(iv) each gas cylinder in the second and fourth columns are partially received by one or more of the interstitial spaces; and
(v) a pair of stack channels and a pair of stack protrusions are alternatingly defined in the first engagement side and the second engagement side; and
(c) for each palletized cargo unit in the set
(i) the first engagement side of the palletized cargo unit is in sequential engagement with the first engagement side of a sequentially adjacent palletized cargo unit; or
(ii) the second engagement side of the palletized cargo unit is in sequential engagement with the second engagement side of a sequentially adjacent palletized cargo unit.

20: The system of claim 19, wherein for each adjacent pair of palletized cargo units in the set, the sequential engagement results in stack protrusions of each of the palletized cargo unit being received by stack channels of the other palletized cargo unit.

21: The system of claim 20, wherein
(a) each handle portion includes a relief gap; and
(b) in the third array, a pair of fork relief zones are defined in part by
(i) the relief gaps of the gas cylinders in the first column facing toward the second column;
(ii) the relief gaps of the gas cylinders in the second column facing toward the first column;
(iii) the relief gaps of the gas cylinders in the third column face toward the fourth column; and
(iv) the relief gaps of the gas cylinders in the fourth column face toward the third column;
wherein each fork relief zone is configured to receive a corresponding fork of the forklift.

22: The system of claim 21, wherein each of the palletized cargo units comprises a sixth array of gas cylinders, wherein
(a) the sixth array is disposed above the fifth array and includes eight gas cylinders;
(b) the tank main axes of the gas cylinders in the sixth array are perpendicular to the tank main axes of the gas cylinders in the fifth array; and
(c) the tank main axes of two of the gas cylinders in the sixth array are perpendicular to the tank main axes of the other six gas cylinders in the sixth array.

23: The system of claim 22, wherein the sixth array is at least partially retained within a cardboard housing.

24: The system of claim 22, wherein
(a) the intermediate pallet includes a pair of handle retention lips laterally opposed from one another; and
(b) the base pallet includes a pair of foot retention lips laterally opposed from one another.

25: The system of claim 24, wherein
(a) in each gas cylinder, a strap aperture is defined at the handle portion;
(b) in each palletized cargo unit
(i) a lower cargo grouping is defined at least in part by the combination of the base pallet, and the first array, second array and third array of gas cylinders;
(ii) an upper cargo grouping is defined at least in part by the combination of the intermediate pallet and the fourth array, fifth array and sixth array of gas cylinders;
(iii) a first vertical securement strap extends in closed loop fashion through the base pallet and through the strap apertures of the gas cylinders in the first column of the third array;
(iv) a second vertical securement strap extends in closed loop fashion through the base pallet and through the strap apertures of the gas cylinders in the fourth column of the third array;
(iv) a first horizontal securement strap extends in closed loop fashion around the third array;
(v) a third vertical securement strap extends in closed loop fashion under the intermediate pallet and through the strap apertures of the gas cylinders in the first column of the fifth array;
(vi) a fourth vertical securement strap extends in closed loop fashion under the intermediate pallet and through the strap apertures of the gas cylinders in the fourth column of the fifth array; and
(iv) a second horizontal securement strap extends in closed loop fashion around the fifth array.

26: The system of claim 25, wherein each of the palletized cargo units include a plastic wrapping enveloping and collectively securing all of the arrays and the intermediate pallet.

27: The system of claim 26, wherein
(a) each base pallet includes a pair of lateral sled rails disposed apart from one another;
(b) each lateral sled rail includes
(i) opposing rail ends;
(ii) a deck interface surface with vertical chamfers extending from the deck interface surface to each rail end; and
(iii) an outboard face perpendicular to the deck interface surface and having base lateral chamfers extending to each rail end.

28: The system of claim 27, wherein each handle retention lip includes
(a) a pair of opposing handle retention lip ends; and
(b) intermediate lateral chamfers at each of the handle retention lip ends.

29: The system of claim 21, wherein each palletized cargo unit includes a pair of fork relief zone tubes, each of the fork relief zone tubes extending through a respective one of the fork relief zones.

30. (canceled)

31: A palletized cargo unit comprising:
(a) a base pallet configured to receive forks of a forklift;
(b) an intermediate pallet including a plurality of handle pass-through apertures;
(c) a first array of gas cylinders;
(d) a second array of gas cylinders disposed above the first array of gas cylinders;
(e) a third array of gas cylinders disposed above the second array of gas cylinders;
(f) a fourth array of gas cylinders disposed above the third array of gas cylinders; and
(g) a fifth array of gas cylinders disposed above the fourth array of gas cylinders;
wherein
(i) each of the gas cylinders includes a foot portion, a handle portion, and a tank main axis extending from the foot portion through the handle portion;
(ii) for each of the first, second, third and fourth arrays of gas cylinders, the handle portion of each gas cylinder in the array is at least partially received by the foot portion of a corresponding one of the gas cylinders in the array disposed thereabove; and
(iii) the handle portion of each gas cylinder in the third array at least partially extends through a corresponding one of the handle pass-through apertures; and
wherein
(a) each handle portion includes one or more handle lips; and
(b) the intermediate pallet is vertically supported by the handle lips of the gas cylinders in the third array.

32: The palletized cargo unit of claim 31, wherein
(a) the palletized cargo unit includes
(i) a first engagement side and a second engagement side opposite thereof;
(ii) a slide axis extending from the first engagement side to the second engagement side; and
(iii) a pair of opposing lateral sides disposed in parallel to the slide axis;
(b) each array includes four consecutive columns of gas cylinders disposed in parallel to the slide axis;
(c) the first and third column of each array includes four gas cylinders, and the second and fourth column of each array includes three gas cylinders;
(d) interstitial spaces are defined between the gas cylinders in the first and third columns;
(e) each gas cylinder in the second and fourth columns are partially received by one or more of the interstitial spaces; and
(f) a pair of stack channels and a pair of stack protrusions are alternatingly defined in the first engagement side and the second engagement side.

33: The palletized cargo unit of claim 32, wherein
(a) each handle portion includes a relief gap; and
(b) in the third array, a pair of fork relief zones are defined in part by
(i) the relief gaps of the gas cylinders in the first column facing toward the second column;
(ii) the relief gaps of the gas cylinders in the second column facing toward the first column;
(iii) the relief gaps of the gas cylinders in the third column face toward the fourth column;
(iv) the relief gaps of the gas cylinders in the fourth column face toward the third column; and
(c) each fork relief zone is configured to receive a corresponding fork of the forklift.

34: The palletized cargo unit of claim 33, wherein
(a) the palletized cargo unit comprises a sixth array of gas cylinders;
(b) the sixth array is disposed above the fifth array and includes eight gas cylinders;
(c) the tank main axes of the gas cylinders in the sixth array are perpendicular to the tank main axes of the gas cylinders in the fifth array; and
(d) the tank main axes of two of the gas cylinders in the sixth array are perpendicular to the tank main axes of the other six gas cylinders in the sixth array.

35: The palletized cargo unit of claim 34, wherein the sixth array is at least partially retained within a cardboard housing.

36: The palletized cargo unit of claim 34, wherein
(a) the intermediate pallet includes a pair of handle retention lips laterally opposed from one another; and
(b) the base pallet includes a pair of foot retention lips laterally opposed from one another.

37: The palletized cargo unit of claim 36, wherein
(a) the base pallet includes a pair of lateral sled rails disposed apart from one another; and
(b) each lateral sled rail includes
(i) opposing rail ends;
(ii) a deck interface surface with vertical chamfers extending from the deck interface surface to each rail end; and
(iii) an outboard face perpendicular to the deck interface surface and having base lateral chamfers extending to each rail end.

38: The palletized cargo unit of claim 37, wherein each handle retention lip includes
(a) a pair of opposing handle retention lip ends; and
(b) intermediate lateral chamfers at each of the handle retention lip ends.

39: A palletized cargo unit comprising:
(a) a base pallet configured to receive forks of a forklift;
(b) an intermediate pallet including a plurality of handle pass-through apertures;
(c) a first array of gas cylinders;
(d) a second array of gas cylinders disposed above the first array of gas cylinders;
(e) a third array of gas cylinders disposed above the second array of gas cylinders;
(f) a fourth array of gas cylinders disposed above the third array of gas cylinders; and
(g) a fifth array of gas cylinders disposed above the fourth array of gas cylinders;
wherein
(i) each of the gas cylinders includes a foot portion, a handle portion, and a tank main axis extending from the foot portion through the handle portion;
(ii) for each of the first, second, third and fourth arrays of gas cylinders, the handle portion of each gas cylinder in the array is at least partially received by the foot portion of a corresponding one of the gas cylinders in the array disposed thereabove; and
(iii) the handle portion of each gas cylinder in the third array at least partially extends through a corresponding one of the handle pass-through apertures; and
wherein
(a) each gas cylinder includes a strap aperture at the handle portion;
(b) a lower cargo grouping is defined at least in part by the combination of the base pallet, and the first array, second array and third array of gas cylinders;
(c) an upper cargo grouping is defined at least in part by the combination of the intermediate pallet and the fourth array, fifth array and sixth array of gas cylinders;
(d) a first vertical securement strap extends in closed loop fashion through the base pallet and through the strap apertures of the gas cylinders in the first column of the third array;
(e) a second vertical securement strap extends in closed loop fashion through the base pallet and through the strap apertures of the gas cylinders in the fourth column of the third array;
(f) a first horizontal securement strap extends in closed loop fashion around the third array;
(g) a third vertical securement strap extends in closed loop fashion under the intermediate pallet and through the strap apertures of the gas cylinders in the first column of the fifth array;
(h) a fourth vertical securement strap extends in closed loop fashion under the intermediate pallet and through the strap apertures of the gas cylinders in the fourth column of the fifth array; and
(i) a second horizontal securement strap extends in closed loop fashion around the fifth array.

40. (canceled)

41: A palletized cargo unit comprising:
(a) a base pallet configured to receive forks of a forklift;
(b) an intermediate pallet including a plurality of handle pass-through apertures;
(c) a first array of gas cylinders;
(d) a second array of gas cylinders disposed above the first array of gas cylinders;
(e) a third array of gas cylinders disposed above the second array of gas cylinders;
(f) a fourth array of gas cylinders disposed above the third array of gas cylinders; and
(g) a fifth array of gas cylinders disposed above the fourth array of gas cylinders;
wherein
(i) each of the gas cylinders includes a foot portion, a handle portion, and a tank main axis extending from the foot portion through the handle portion;
(ii) for each of the first, second, third and fourth arrays of gas cylinders, the handle portion of each gas cylinder in the array is at least partially received by the foot portion of a corresponding one of the gas cylinders in the array disposed thereabove; and
(iii) the handle portion of each gas cylinder in the third array at least partially extends through a corresponding one of the handle pass-through apertures;
wherein the palletized cargo unit further comprises an extraction line which
(a) has a securement end and a terminal end, the securement end being coupled to the base pallet; and
(b) is reconfigurable between a bundled configuration and an extended configuration; and
wherein the extraction line is comprised of a single segment of rope with opposing rope ends, the terminal end of the extraction line being defined by a joining of the rope ends, the securement end of the extraction line being defined by a loop portion of the rope disposed between the rope ends.

42: The palletized cargo unit of claim 41, wherein the joining of the rope ends is by way of a knot.

43: A palletized cargo unit comprising:
(a) a base pallet configured to receive forks of a forklift;
(b) an intermediate pallet including a plurality of handle pass-through apertures;
(c) a first array of gas cylinders;
(d) a second array of gas cylinders disposed above the first array of gas cylinders;
(e) a third array of gas cylinders disposed above the second array of gas cylinders;
(f) a fourth array of gas cylinders disposed above the third array of gas cylinders; and
(g) a fifth array of gas cylinders disposed above the fourth array of gas cylinders;
wherein
(i) each of the gas cylinders includes a foot portion, a handle portion, and a tank main axis extending from the foot portion through the handle portion;
(ii) for each of the first, second, third and fourth arrays of gas cylinders, the handle portion of each gas cylinder in the array is at least partially received by the foot portion of a corresponding one of the gas cylinders in the array disposed thereabove; and
(iii) the handle portion of each gas cylinder in the third array at least partially extends through a corresponding one of the handle pass-through apertures;
wherein the palletized cargo unit further comprises an extraction line which
(a) has a securement end and a terminal end, the securement end being coupled to the base pallet; and
(b) is reconfigurable between a bundled configuration and an extended configuration; and
wherein the base pallet includes one or more medial sled rails having a coupling aperture therein, the coupling aperture being configured to have the securement end of the respective extraction line pass therethrough.

44: The palletized cargo unit of claim 33, further comprising a pair of fork relief zone tubes, each of the fork relief zone tubes extending through a respective one of the fork relief zones.

45. (canceled)
